(19) United States
(12) Patent Application Publication
(10) Pub. No.: US 2026/0338022 A1
(43) Pub. Date: Oct. 29, 2026

(54) REFRIGERATOR AND HOME APPLIANCE COMPRISING SAME

(71) Applicant: SAMSUNG ELECTRONICS CO., LTD., Suwon-si (KR)

(72) Inventors: Changhoon IM, Suwon-si (KR); Hanvit SEO, Suwon-si (KR); Yongsuk KWAK, Suwon-si (KR); Hankwon KIM, Suwon-si (KR); Minseok PARK, Suwon-si (KR); Jin YOU, Suwon-si (KR); Yeohwan YOON, Suwon-si (KR); Hyunsik YUN, Suwon-si (KR)

(73) Assignee: SAMSUNG ELECTRONICS CO., LTD., Suwon-si (KR)

(21) Appl. No.: 19/647,350

(22) Filed: Apr. 14, 2026

Related U.S. Application Data
(63) Continuation of application No. PCT/KR2024/013919, filed on Sep. 12, 2024.

(30) Foreign Application Priority Data
Oct. 14, 2023 (KR) 10-2023-0137218
Nov. 10, 2023 (KR) 10-2023-0155616

(51) Int. Cl. E05F 15/614; F25D 23/02

(52) U.S. Cl. CPC E05F 15/614; F25D 23/028; E05Y 2201/41; E05Y 2201/422; E05Y 2201/71; E05Y 2900/31; F25D 2323/02

(57) ABSTRACT

An appliance includes: a door; and a door opening and closing device configured to open and close the door, wherein the door opening and closing device includes: a motor; a first gear configured to receive power from the motor, the first gear including a hollow portion, a plurality of groove portions formed along a circumferential direction on an inner circumferential surface, and a groove wall disposed between the plurality of groove portions; a second gear including a rotation shaft inserted into the hollow portion of the first gear; and an elastic body coupled to the rotation shaft and having an elastic force in a radial direction of the rotation shaft, a portion of the elastic body being inserted into a groove portion of the plurality of groove portions of the first gear.

### CROSS-REFERENCE TO RELATED APPLICATIONS

This application is a continuation of International Application No. PCT/KR2024/013919, filed on Sept. 12, 2024, which is based on and claims to Korean Patent Application No. 10-2023-0137218, filed on Oct. 14, 2023, and Korean Patent Application No. 10-2023-0155616, filed on Nov. 10, 2023, in the Korean Intellectual Property Office, the disclosures of which are incorporated by reference herein in their entireties.

### BACKGROUND

### 1. Field

The present disclosure is directed to home appliances and, more specifically, to an automatic door opening and closing structure of a refrigerator and a home appliance including the same.

### 2. Description of Related Art

In general, a home appliance such as a refrigerator, a dishwasher, or a cooking device (e.g., an oven) is provided with a door configured to be openable and closable to access an inner space.

The door may include a manual opening and closing type door configured to be directly opened and closed by a user, and an automatic opening and closing type door configured to be automatically opened and closed using a door opening and closing device according to a user input. In the automatic opening/closing door, the user may move the door by directly exerting force at any time while the door is automatically opened or closed. In this case, a load may be generated on a motor of the door opening and closing device due to an external force by the user, and thus damage may occur to the motor or performance of the motor may be degraded. As an example, a method may be proposed in which a current load applied to the motor is detected to determine whether the user has intervened, and operation of the motor is stopped in a case that the user intervenes.

The above-described information may be provided as related art for the purpose of assisting understanding of the disclosure. No claim or determination is made as to whether any of the foregoing is applicable as background art in relation to the disclosure.

### SUMMARY

Provided is an automatic door opening and closing structure of an appliance that may prevent a load from being applied to a motor even in case that a user applies a force to a door while performing an automatic opening or closing operation of the door.

According to an aspect of the disclosure, an appliance includes: a door; and a door opening and closing device configured to open and close the door, wherein the door opening and closing device includes: a motor; a first gear configured to receive power from the motor, the first gear including a hollow portion, a plurality of groove portions formed along a circumferential direction on an inner circumferential surface, and a groove wall disposed between the plurality of groove portions; a second gear including a rotation shaft inserted into the hollow portion of the first gear; and an elastic body coupled to the rotation shaft and having an elastic force in a radial direction of the rotation shaft, a portion of the elastic body being inserted into a groove portion of the plurality of groove portions of the first gear.

The door opening and closing device may be configured to transmit power of the first gear to the second gear in a state in which the elastic body is caught on or in contact with the groove wall.

The plurality of groove portions may include a first groove portion and a second groove portion, and the groove wall is located between the first groove portion and the second groove portion.

A circumferential length of the first groove portion and a circumferential length of the second groove portion may be substantially equal.

While the elastic body moves along one groove portion among the plurality of groove portions, power transmission between the first gear and the second gear may be configured to be released.

The door opening and closing device further may include a door-side gear configured to transmit power between the second gear and the door.

A diameter of the rotation shaft may be smaller than a diameter of the hollow portion of the first gear.

In a case that the motor is driven such that the first gear rotates in a first direction, the door may open, and, in a case that the motor is driven such that the first gear rotates in a second direction opposite to the first direction, the door may close.

The elastic body may include an upper elastic body and a lower elastic body spaced apart from each other in a vertical direction, and the plurality of groove portions may include an upper groove portion and a lower groove portion spaced apart from each other in the vertical direction.

The elastic body may include: a body portion; a spring received within the body portion; and a head portion supported by one side of the spring, a portion of the head portion being received within the body portion.

The head portion may have a ball shape.

In a case that the first gear is rotated in a first direction by the motor and the second gear is rotated in a second direction opposite to the first direction by an external force, the elastic body may be configured to pass through the groove wall and move along an adjacent other groove portion.

The motor may be configured to continue operating according to a predetermined input value in a case that a force acts in an opposite direction while being driven to open or close the door.

The elastic body may be a ball plunger.

The appliance may be at least one of a refrigerator, a dishwasher, or a cooking device.

The effects obtainable from embodiments of the disclosure are not limited to the effects mentioned above, and other effects not mentioned may be clearly derived and understood by those of ordinary skill in the art to which the embodiments of the disclosure belong from the following description. In other words, unintended effects in practicing embodiments of the disclosure may also be derived by one of ordinary skill in the art from embodiments of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a schematic internal and external appearance of a refrigerator, according to an embodiment of the present disclosure;

FIG. 2 is a view illustrating an upper portion of a refrigerator, according to an embodiment of the present disclosure;

FIG. 3 is a view illustrating an automatic door opening and closing structure of a refrigerator, according to an embodiment of the present disclosure;

FIG. 4 is a view illustrating a door opening and closing device, according to an embodiment of the present disclosure;

FIG. 5 is a side view illustrating a portion of a configuration of a door opening and closing device, according to an embodiment of the present disclosure;

FIG. 6 is a view illustrating a clutch gear unit, according to an embodiment of the present disclosure;

FIG. 7 is an exploded view illustrating a clutch gear unit, according to an embodiment of the present disclosure;

FIG. 8 is a plan view illustrating a first clutch gear, according to an embodiment of the present disclosure;

FIGS. 9A, 9B, 9C, 9D, and 9E are views illustrating an operation of a clutch gear unit during an automatic door opening and closing operation, according to an embodiment of the present disclosure;

FIGS. 10A, 10B, and 10C are views illustrating an operation of a clutch gear unit in a circumstance where a door opening and closing operation is switched from automatic to manual, according to an embodiment of the present disclosure;

FIG. 11 is a view illustrating an elastic body, according to an embodiment of the present disclosure;

FIG. 12 is a cross-sectional view illustrating a clutch gear unit, according to an embodiment of the present disclosure;

FIG. 13 is a view illustrating a clutch gear unit, according to an embodiment of the present disclosure;

FIG. 14 is a perspective view illustrating a dishwasher, according to an embodiment of the present disclosure;

FIG. 15 is a side cross-sectional view illustrating a dishwasher, according to an embodiment of the present disclosure;

FIG. 16 is a perspective view illustrating a state in which a door is opened in a dishwasher, according to an embodiment of the present disclosure;

FIG. 17 is a perspective view illustrating a cooking device, according to an embodiment of the present disclosure;

FIG. 18 is a view illustrating a state in which a door of a cooking device is opened, according to an embodiment of the present disclosure; and

FIG. 19 is a side cross-sectional view illustrating a cooking device, according to an embodiment of the present disclosure.

### DETAILED DESCRIPTION

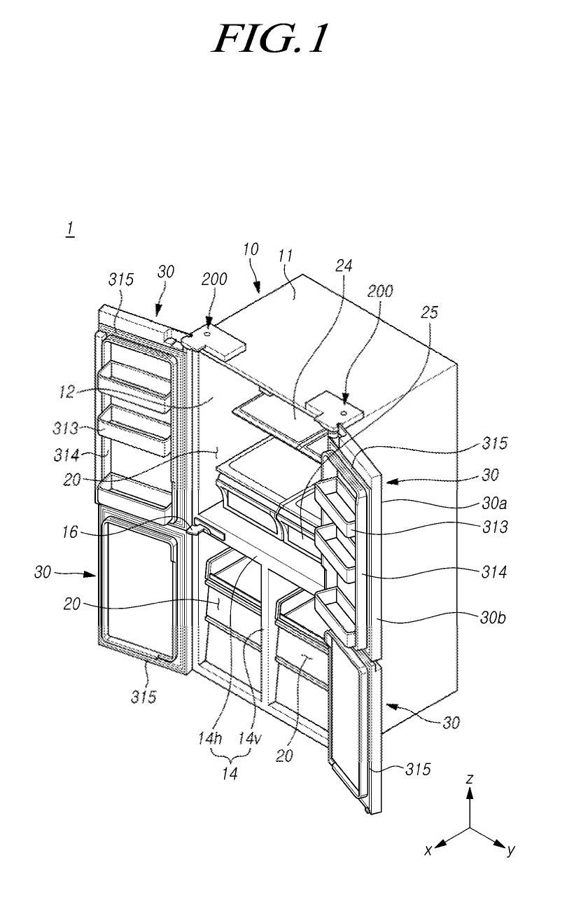

Various example embodiments of the disclosure are described herein with reference to FIGS. 1-19, and should not be interpreted as limiting the scope of the disclosure. Those skilled in the art will understand that the principle of the disclosure may be implemented in any appropriately disposed system or device.

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the expression “at least one of A, B, and C,” should be understood as including only A, only B, only C, both A and B, both A and C, both B and C, or all of A, B, and C.

The term “and/or” may denote a combination(s) of a plurality of related components as listed or any of the components.

Terms such as “first” or “second” may be used simply to distinguish the corresponding component from another corresponding component, and do not limit the corresponding components in other aspects (e.g., importance or order).

As used herein, the terms ‘front surface,’ ‘rear surface,’ ‘upper surface,’ ‘side surface,’ ‘left side,’ ‘right side,’ ‘upper portion,’ and ‘lower portion’ are defined with respect to the drawings, and the shape and position of each component are not limited by the terms.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that in a case that a component is referred to as “connected to,” “coupled to”, “supported on,” or “contacting” another component, the components may be connected to, coupled to, supported on, or contact each other directly or via a third component.

Throughout the specification, in a case that one component is disposed “on” another component, the component may be disposed directly on the other component, or other component(s) may be disposed between the two components.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

The refrigerator according to an embodiment may include a main body.

The “main body” may include an inner case, an outer case disposed outside the inner case, and an insulation material provided between the inner case and the outer case.

The “inner case” may include at least one of a case, a plate, a panel, or a liner forming a storage compartment. The inner case may be formed as a single body or may be formed by assembling a plurality of plates. The “outer case” may form the outer appearance of the main body and may be coupled to an outer side of the inner case so that the insulation material is disposed between the inner case and the outer case.

The “insulation material” may insulate the inside of the storage compartment and the outside of the storage compartment so that the temperature inside the storage compartment is maintained at a set appropriate temperature without being affected by the environment outside the storage compartment. According to an embodiment, the insulation material may include a foam insulation material. The foam insulation material may be formed by injecting and foaming a urethane foam formed by mixing polyurethane and a foaming agent between the inner case and the outer case.

According to an embodiment, the insulation material may further include a vacuum insulation material in addition to the foam insulation material, or the insulation material may be composed of a vacuum insulation material instead of the foam insulation material. The vacuum insulation material may include a core material and an outer cover material that accommodates the core material and seals the inside at a pressure close to vacuum or vacuum. However, the insulation material is not limited to the foam insulation material or the vacuum insulation material, and may include various materials that may be used for insulation.

The “storage compartment” may include a space limited by the inner case. The storage compartment may further include an inner case that limits a space corresponding to the storage compartment. Various items such as food, medicine, cosmetics, etc. may be stored in the storage compartment, and the storage compartment may be formed so that at least one side thereof is opened to take in and out the items.

A refrigerator may include one or more storage compartments. In a case that two or more storage compartments are formed in the refrigerator, each storage compartment may have a different use and may be maintained at a different temperature. To that end, each storage compartment may be partitioned from each other by a partition wall including an insulation material.

The storage compartment may be provided to be maintained in an appropriate temperature range according to the use, and may include a “refrigerating compartment”, a “freezing compartment”, or a “variable temperature compartment” divided by the use and/or temperature range thereof. The refrigerating compartment may be maintained at a temperature suitable for refrigerating and storing items, and the freezing compartment may be maintained at a temperature suitable for freezing and storing items. The term “refrigerating” may mean cooling the item to the extent that the item is not frozen, and for example, the refrigerating compartment may be maintained in the range of 0 degrees Celsius to 7 degrees Celsius. The term “freezing” may mean cooling the item to freeze or remain frozen, and for example, the freezing compartment may be maintained in the range of minus 20 degrees Celsius to minus 1 degree Celsius. The variable temperature compartment may be used as any one of the refrigerating compartment or the freezing compartment regardless of the user’s selection.

The storage compartment may be referred to as a “vegetable compartment”, a “fresh compartment”, a “cooling compartment”, an “ice-making compartment”, and the like, in addition to the names “refrigerating compartment”, “freezing compartment”, and “variable temperature compartment”, and the terms “refrigerating compartment”, “freezing compartment”, and “variable temperature compartment” used below should be understood to collectively mean storage compartments having their respective corresponding uses and temperature ranges.

According to an embodiment, the refrigerator may include at least one door configured to open and close one open side of the storage compartment. The door may be provided to open and close each of one or more storage compartments, or one door may be provided to open and close a plurality of storage compartments. The door may be rotatably or slidably installed on the front surface of the main body.

The “door” may be configured to seal the storage compartment in a case that the door is closed. Like the main body, the door may include an insulation material to insulate the storage compartment in a case that the door is closed.

According to an embodiment, the door may include a door outer plate forming a front surface of the door, a door inner plate forming a rear surface of the door and facing the storage compartment, an upper cap, a lower cap, and a door insulation material provided thereinside.

A gasket may be provided on the edge of the door inner plate to seal the storage compartment by being in close contact with the front surface of the main body in a case that the door is closed. The door inner plate may include a dyke protruding rearward to mount a door basket capable of storing an object.

According to an embodiment, the door may include a door body and a front panel detachably coupled to a front side of the door body and forming a front surface of the door. The door body may include a door outer plate forming a front surface of the door body, a door inner plate forming a rear surface of the door body and facing the storage compartment, an upper cap, a lower cap, and a door insulation material provided thereinside.

The refrigerator may be classified into a French door type, a side-by-side type, a bottom mounted freezer (BMF), a top mounted freezer (TMF), or a one-door refrigerator according to the arrangement of the door and the storage compartment.

According to an embodiment, the refrigerator may include a cold air supply device configured to supply cold air to the storage compartment.

The “cold air supply device” may include a machine, an instrument, an electronic device, and/or a system combining the machine, the instrument, and the electronic device capable of generating cold air and guiding the cold air to cool the storage compartment.

According to an embodiment, the cold air supply device may generate cold air through a refrigerating cycle including processes of compressing, condensing, expanding, and evaporating the refrigerant. To that end, the cold air supply device may include a refrigerating cycle device having a compressor, a condenser, an expansion device, and an evaporator capable of driving the refrigerating cycle. According to an embodiment, the cold air supply device may include a semiconductor such as a thermoelectric element. The thermoelectric element may cool the storage compartment by heating and cooling through the Peltier effect.

According to an embodiment, the refrigerator may include a machine room in which at least some components belonging to the cold air supply device are arranged.

The “machine room” may be provided to be partitioned and insulated from the storage compartment to prevent heat generated from components disposed in the machine room from being transferred to the storage compartment. The inside of the machine room may be configured to communicate with the outside of the main body to dissipate heat from components disposed inside the machine room.

According to an embodiment, the refrigerator may include a dispenser provided on the door to provide water and/or ice. The dispenser may be provided on the door to be accessed by the user without opening the door.

According to an embodiment, the refrigerator may include an ice maker provided to generate ice. The ice maker may include an ice-making tray storing water, an ice-separating device separating ice from the ice-making tray, and an ice bucket storing ice generated in the ice-making tray.

According to an embodiment, the refrigerator may include a controller for controlling the refrigerator.

The “controller” may include a memory storing or recording a program and/or data for controlling the refrigerator, and a processor outputting a control signal for controlling the cold air supply device according to the program and/or data stored in the memory.

The memory may store or record various information, data, instructions, programs, etc. for the operation of the refrigerator. The memory may store temporary data generated while generating a control signal for controlling components included in the refrigerator. The memory may include at least one of a volatile memory, a non-volatile memory or a combination thereof.

At least one processor (hereafter “the processor”) may control the overall operation of the refrigerator. The processor may control the components of the refrigerator by executing a program stored in the memory. The processor may include a separate NPU that performs the operation of the artificial intelligence model. The processor may include a central processing unit (CPU), a graphics processing unit (GPU), and the like. The processor may generate a control signal for controlling the operation of the cold air supply device. For example, the processor may receive temperature information about the storage compartment from the temperature sensor, and generate a cooling control signal for controlling the operation of the cold air supply device based on the temperature information about the storage compartment.

Further, the processor may process the user input of the user interface according to the program and/or data stored in the memory, and control the operation of the user interface. The user interface may be provided using an input interface and an output interface. The processor may receive a user input from the user interface. Further, the processor may transfer a display control signal and image data for displaying an image on the user interface to the user interface in response to the user input.

The processor and the memory may be provided integrally or separately. The processor may include one or more processors. For example, the processor may include a main processor and at least one sub-processor. The memory may include one or more memories.

The refrigerator may include a processor and a memory controlling all components included in the refrigerator, and a plurality of processors and a plurality of memories individually controlling the components of the refrigerator. For example, the refrigerator may include a processor and a memory controlling the operation of the cold air supply device according to the output of the temperature sensor. Further, the refrigerator may include a separate processor and a separate memory controlling the operation of the user interface according to a user input.

The communication module may communicate with an external device such as a server, a mobile device, another home appliance, or the like through an access point (AP). The AP may connect the local area network (LAN) to which the refrigerator or the user equipment is connected to the wide area network (WAN) to which the server is connected. The refrigerator or the user device may be connected to the server through the wide area network (WAN).

The input interface may include a key, a touch screen, a microphone, and the like. The input interface may receive a user input and transfer the user input to the processor.

The output interface may include a display, a speaker, and the like. The output interface may output various notifications, messages, information, and the like generated by the processor.

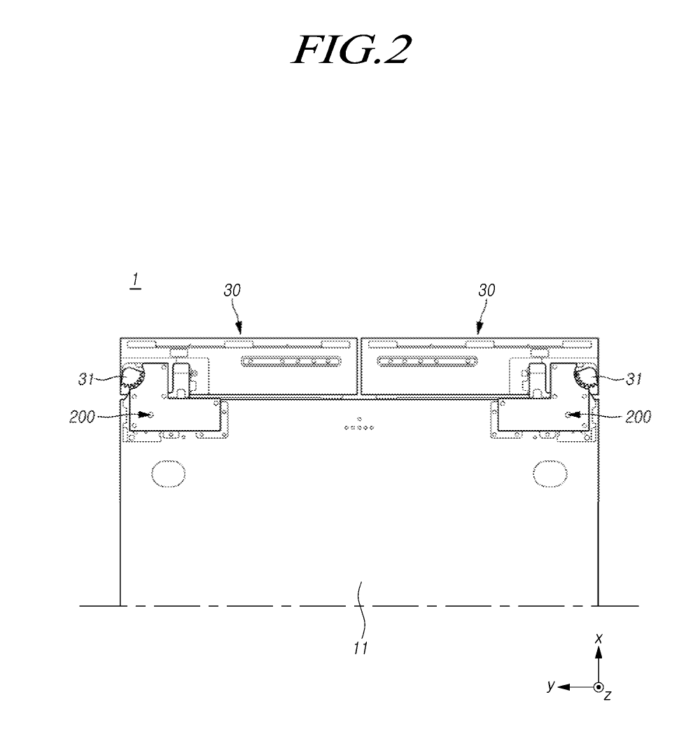

FIG. 1 is a view schematically illustrating an inner/outer appearance of a refrigerator, according to an embodiment of the present disclosure. FIG. 2 is a view illustrating an upper portion of a refrigerator, according to an embodiment of the present disclosure.

FIGS. 1 and 2 illustrate views illustrating a refrigerator as an example of a home appliance.

Referring to FIGS. 1 and 2, a refrigerator 1 may include a main body 10. The main body 10 may include an outer case 11 and an inner case 12 disposed inside the outer case 11. The outer case 11 may be provided to form at least a portion of the outer appearance of the main body 10. In an example, the outer case 11 may be configured to include a metal material having excellent durability and aesthetics. The inner case 12 may be provided to define a space of the storage compartment 20. For example, the storage compartment 20 may be provided in the main body 10.

The inner case 12 may include a case, a plate, a panel, and/or a liner forming the storage compartment 20. The inner case 12 may be formed as a single body or may be formed by assembling a plurality of plates. In an example, the inner case 12 may be integrally injection-molded using a plastic material, but embodiments of the disclosure are not limited thereto.

An accommodation space may be formed between the outer case 11 and the inner case 12. An insulation material for insulating the storage compartment 20 may be provided in at least a portion of the accommodation space. The insulation material may insulate the inside of the storage compartment 20 and the outside of the storage compartment 20 so that the temperature inside the storage compartment 20 may be maintained at a set appropriate temperature without being affected by the external environment of the storage compartment 20.

According to an example, the insulation material may include a foam insulation material. In an example, after fixing the inner case 12 and the outer case 11 with a jig or the like, the foam insulation material may be formed by injecting and foaming a urethane foam mixed with polyurethane and a foaming agent into an accommodation space between the inner case 12 and the outer case 11. According to an embodiment, the insulation material may include a vacuum insulation material in addition to the foam insulation material or in place of the foam insulation material. The vacuum insulation material may include a core material and an outer cover material that accommodates the core material and seals the inside at a pressure close to vacuum or vacuum. The vacuum insulation material may further include an adsorbent that adsorbs gas and moisture to maintain a stable vacuum state. The insulation material of the refrigerator 1 is not limited to the foam insulation material or vacuum insulation material described above, but may be configured using various materials that may be used for insulation.

According to an embodiment, the refrigerator 1 may include a storage compartment 20. The storage compartment 20 may store food. Food includes things that may be eaten or drunk, and specifically, may include meat, fish, seafood, fruits, vegetables, water, ice, beverages, kimchi, or alcoholic beverages such as wine. Drugs and cosmetics may be stored in the storage compartment 20 in addition to food, but there is no limitation on items that may be stored in the storage compartment 20.

According to an example, the refrigerator 1 may include one or more storage compartments 20. In a case that two or more storage compartments 20 are formed in the refrigerator 1, each storage compartment may have a different use and may be maintained at a different temperature. To that end, the storage compartments 20 may be partitioned from each other by a partition wall 14 including an insulation material. In an example, the storage compartment may be referred to as a “refrigerating compartment”, a “freezing compartment”, or a “variable temperature compartment” according to the use and/or the temperature range. For example, the refrigerating compartment may refer to a storage chamber in a case that food is maintained at an appropriate temperature for refrigerating and storing, and the freezing compartment may refer to a storage chamber in a case that food is maintained at an appropriate temperature for freezing and storing. Refrigerating may refer to cooling food to the extent that the food is not frozen, and for example, the refrigerating compartment may be maintained in the range of 0 degrees Celsius to 7 degrees Celsius. Freezing may mean freezing food or cooling food to remain frozen, and for example, the freezing compartment may be maintained in the range of minus 20 degrees Celsius to minus 1 degree Celsius. The variable temperature compartment may refer to a storage compartment that may be maintained at a predetermined variable temperature by the user’s selection or regardless of the user’s selection. According to an embodiment, one storage compartment may be provided so that a portion thereof is used as a refrigerating compartment and the remaining portion thereof is used as a freezing compartment. Storage compartments may be referred to by various names such as “vegetable compartment”, “fresh compartment”, “cooling compartment”, and “ice making compartment” in addition to the above-described names such as “refrigeration compartment”, “freezing compartment”, and “variable temperature compartment”.

According to an example, the number, size, and/or shape of the storage compartment 20 may vary depending on the shape or position of the partition wall 14. According to an embodiment, the partition wall 14 may be integrally formed with the main body 10. According to an embodiment, the partition wall 14 may be a separate partition provided separately from the main body 10 and assembled to the main body 10.

According to an example, the storage compartment 20 may be partitioned left and right by a vertical partition wall 14v (a partition wall extending in the vertical direction). The size of the storage compartment 20 partitioned left and right may vary depending on the position of the vertical partition wall 14v. For example, the storage compartment 20 in which the vertical partition wall 14v is provided in the middle and partitioned left and right may be provided in mirror symmetry. According to an embodiment, there may be a plurality of vertical partition walls. In a case that there are a plurality of vertical partition walls, the storage compartment may be divided into three or more storage compartments along the left and right directions.

According to an example, the storage compartment 20 may be vertically partitioned by a horizontal partition wall 14h (a partition wall extending in the horizontal direction). The size of the storage compartment 20 divided vertically may vary depending on the position of the horizontal partition wall 14h. According to an embodiment, there may be a plurality of horizontal partition walls. In a case that there are a plurality of horizontal partition walls, the storage compartment may be divided into three or more storage compartments in the vertical direction.

The refrigerator may be configured to include a plurality of storage compartments having various sizes and shapes according to various combinations of the vertical partition wall and the horizontal partition wall.

According to an example, a plurality of shelves 24 and/or a plurality of storage containers 25 may be provided inside the storage compartment 20. Each of the plurality of shelves 24 and the plurality of storage containers 25 may be separable from an inner space of the storage compartment 20.

According to an example, each storage compartment 20 may be formed so that at least one side thereof is open for loading and unloading food. According to an embodiment, the refrigerator 1 may include each door 30 for opening and closing each storage compartment 20. The storage compartment 20 may have, e.g., an open front surface. In an example, the door 30 may be disposed on the front surface of the main body 10 and the storage compartment 20 to open and close the storage compartment 20. The door 30 may be configured to seal the storage compartment 20 while the door is closed. Like the main body 10, the door 30 may include an insulation material to insulate the storage compartment 20 from the external environment while the door 30 is closed.

According to an example, the door 30 may be configured to be opened and closed by rotating about the hinge 16, but embodiments of the disclosure are not limited thereto. In an example, the door may be configured to be opened and closed in a sliding manner.

According to an example, the door 30 may include a door panel 30aand/or a door body 30b. The door panel 30aand the door body 30bmay be detachably coupled to each other. For example, one side of the door body 30bmay be fixed to the main body 10 by the hinge 16. The door panel 30amay form a portion of the front outer appearance of the refrigerator 1. Accordingly, the door panel 30amay serve as an element of aesthetics in a case that the refrigerator 1 is disposed indoors. The door panel 30amay have various colors and/or various designs and may be configured to be replaceable so that the user may decorate the front exterior of the refrigerator 1 according to his/her taste. According to an embodiment, the door panel 30aand the door body 30b may be integrally formed with each other.

According to an example, the door 30 may include a door handle, a door shelf 313, a shelf support 314, and/or a gasket 315. The user may open and close the door 30 using the door handle. The door handle may be recessed on the bottom surface or the top surface of the door 30, or may protrude from the front surface of the door 30, but is not limited to a specific shape.

The door shelf 313 may be provided to receive food. Shelf supports 314 may be provided on both left and right sides of the door shelf 313 to support the door shelf 313. The shelf support 314 may extend vertically from, e.g., the door 30. For example, the shelf support 314 may protrude from the rear surface (the inner surface facing the storage compartment 20) of the door 30 toward the storage compartment 20 and may be provided to extend in the vertical direction. The shelf support 314 may be provided as a separate component separable from the door 30, or may be integrally formed with the door 30.

The gasket 315 may be provided to surround an edge of the door body 30b. The gasket 315 may be provided to seal a gap between the main body 10 and the door 30 in a state in which the door 30 is closed.

According to an example, the refrigerator 1 may include a cold air supply device. The cold air supply device may include a machine, an instrument, an electronic device, and/or a system combining the machine, the instrument, and the electronic device capable of generating cold air and guiding the generated cold air to the storage compartment to cool the storage compartment. For example, the cold air supply device may be provided inside the main body 10 to supply cold air to each of the storage compartments 20.

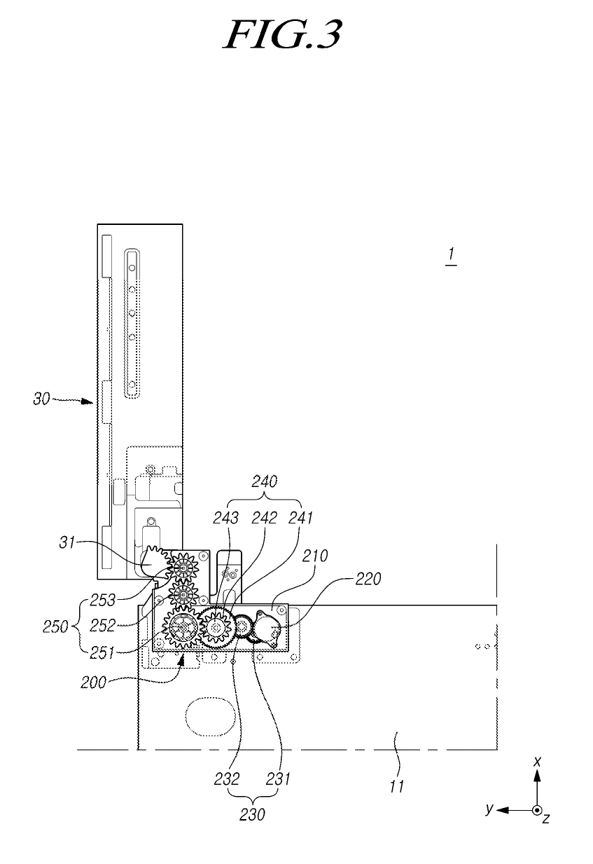

According to an example, the refrigerator 1 may include a door opening and closing device 200. The door opening and closing device 200 may be coupled to each door 30. The door opening and closing device 200 may be disposed on an upper side or a lower side of an outer case 11. The door opening and closing device 200 may be provided to automatically open or close the door 30 by rotating a hinge or a rotation shaft of the door. For example, the door opening and closing device 200 may automatically open or close the door 30 by rotating a hinge gear 31 provided on the door 30 during operation. The door opening and closing device 200 may be configured with a motor (e.g., the motor 220 of FIG. 3) and a plurality of gears for transmitting power of the motor 220. A specific structure and operation method of the door opening and closing device 200 is described below.

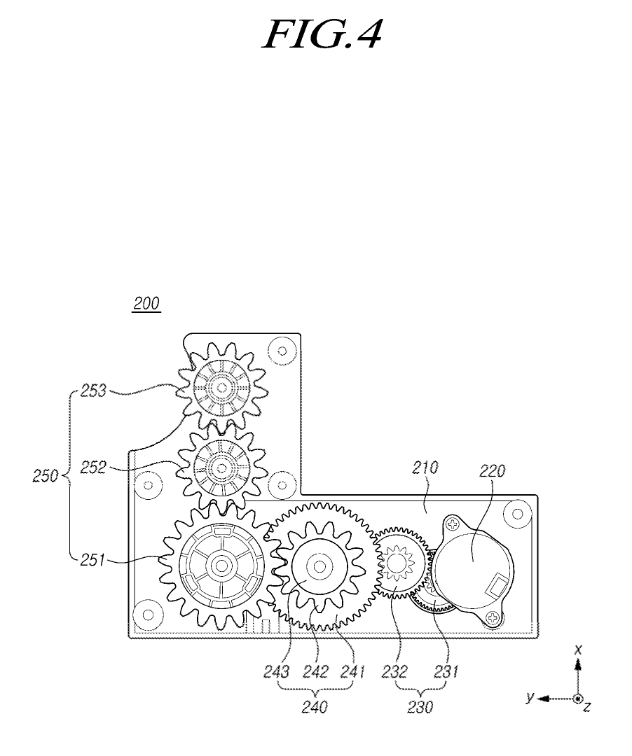

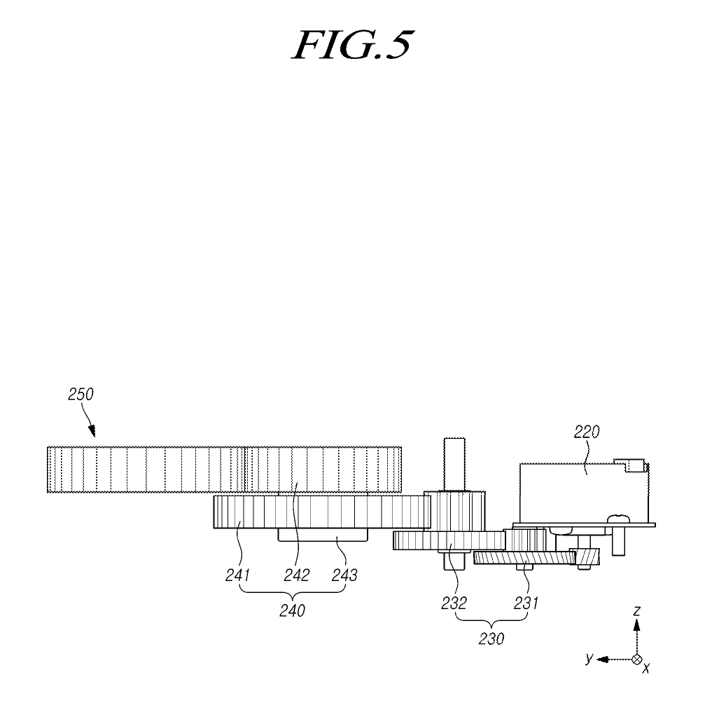

FIG. 3 is a view illustrating an automatic door opening and closing structure of a refrigerator, according to an embodiment of the present disclosure. FIG. 4 is a view illustrating a door opening and closing device, according to an embodiment of the present disclosure. FIG. 5 is a side view illustrating a portion of a configuration of a door opening and closing device, according to an embodiment of the present disclosure.

The refrigerator 1 illustrated in FIGS. 3-5 may be substantially identical or similar to the refrigerator 1 illustrated in FIGS. 1 and 2. Hereinafter, the same reference numerals are used for configurations substantially identical or similar to the configurations described in connection to FIGS. 1 and 2.

Referring to FIGS. 3-5, the refrigerator 1 may include a door opening and closing device 200. In a case that the door opening and closing device 200 operates, the door 30 may be opened or closed by rotating the hinge gear 31 of the door 30. In a case that the door opening and closing device 200 operates, the door 30 may be opened and closed. The door opening and closing device 200 may be a device configured to automatically open or close the door 30 without the user directly applying a force by operating according to an external input or the like.

The door opening and closing device 200 may be, e.g., modularized. In a case that a failure occurs in one of the door opening and closing devices 200 mounted on each door 30 in the refrigerator 1, the problem may be solved by replacing the modularized door opening and closing device 200.

According to an example, the door opening and closing device 200 may include at least one of a housing 210, a motor 220, a motor-side gear unit 230, a clutch gear unit 240, or a door-side gear unit 250. The door opening and closing device 200 may be configured such that power of the motor 220 is transmitted to the hinge gear (e.g., the hinge gear 31 of FIG. 3) through the motor-side gear unit 230, the clutch gear unit 240, and the door-side gear unit 250. The motor-side gear unit 230, the clutch gear unit 240, and the door-side gear unit 250 provided between the motor 220 and the hinge gear 31 may be collectively referred to as a gear assembly.

According to an example, the housing 210 may form an exterior of the door opening and closing device 200. At least one of the motor 220, the motor-side gear unit 230, the clutch gear unit 240, or the door-side gear unit 250 may be received inside the housing 210. The housing 210 may be referred to as a module housing. An opening may be provided in the housing 210. The hinge gear (e.g., the hinge gear 31 of FIG. 3) and the door-side gear unit 250 may be engaged at the opening of the housing 210.

According to an example, the motor 220 may be configured to output power for opening and closing the door 30. The motor 220 may rotate in both directions. The shaft of the motor 220 and one gear (e.g., a first motor-side gear 231) of the motor-side gear unit 230 may be disposed to be engaged. Accordingly, power of the motor 220 may be transmitted to the motor-side gear unit 230.

According to an example, the motor-side gear unit 230 may be disposed between the motor 220 and the clutch gear unit 240. The motor-side gear unit 230 may be configured to transmit power of the motor 220 to the clutch gear unit 240.

According to an example, the motor-side gear unit 230 may include a plurality of gears. The motor-side gear unit 230 may include a first motor-side gear 231 and a second motor-side gear 232. The first motor-side gear 231 and the second motor-side gear 232 may be engaged.

The first motor-side gear 231 may be disposed between the motor 220 and the second motor-side gear 232. The first motor-side gear 231 may be configured to transmit power of the motor 220 to the second motor-side gear 232.

The second motor-side gear 232 may be disposed between the first motor-side gear 231 and the clutch gear unit 240. The second motor-side gear 232 may be configured to transmit power of the first motor-side gear 231 to the clutch gear unit 240.

However, this is an example, and the number of motor-side gears is not limited to two and may be configured with one or three or more.

According to an example, the clutch gear unit 240 may include a first gear 241 and a second gear 242. The second gear 242 may include a rotation shaft 243. The second gear 242 and the rotation shaft 243 may be integrally formed, but embodiments of the disclosure are not limited thereto. The second gear 242 and the rotation shaft 243 may be separately configured and coupled.

According to an example, the first gear 241 may be engaged with the motor-side gear unit 230. For example, the first gear 241 may be engaged with the second motor-side gear 232. The first gear 241 may receive power from the motor-side gear unit 230. The first gear 241 may receive power of the motor 220 through the motor-side gear unit 230 as a medium.

According to an example, the second gear 242 may be disposed to be engaged with the door-side gear unit 250. For example, the second gear 242 may be disposed to be engaged with afirst door-side gear 251. In a case that the second gear 242 receives power from the first gear 241 and rotates, the power may be transmitted to the hinge gear 31, and the door 30 may be opened and closed.

In an example, in a case that a user directly (or manually) opens and closes the door 30, power of the hinge gear 31 rotated by the user’s operation may be transmitted to the second gear 242. In this case, the power of the second gear 242 may not be transmitted to the first gear 241. Therefore, even in a case that the user manually operates the door 30, an external force of the user is not transmitted to the first gear 241, and as a result, a load is not applied to the motor 220, thereby preventing damage to the motor 220. A specific operation process is described below.

The clutch gear unit 240 may receive power of the motor 220 through the motor-side gear unit 230 as a medium.

According to an example, the door-side gear unit 250 may be disposed to be engaged with the clutch gear unit 240. The door-side gear unit 250 may intermittently receive power from the clutch gear unit 240. For example, the door-side gear unit 250 may receive power of the motor 220 through the motor-side gear unit 230 and the clutch gear unit 240 as a medium.

According to an example, the door-side gear unit 250 may include a plurality of gears. The door-side gear unit 250 may include a first door-side gear 251, a second door-side gear 252, and a third door-side gear 253. The first door-side gear 251 and the second door-side gear 252 may be engaged with each other. The second door-side gear 252 and the third door-side gear 253 may be engaged with each other. This is an example, and the number of door-side gears may be configured with at least one.

The first door-side gear 251 may be disposed between the clutch gear unit 240 and the second door-side gear 252. The first door-side gear 251 may be configured to transmit power transmitted to the clutch gear unit 240 to the second door-side gear 252.

The second door-side gear 252 may be disposed between the first door-side gear 251 and the third door-side gear 253. The second door-side gear 252 may be configured to transmit power transmitted to the first door-side gear 251 to the third door-side gear 253.

The third door-side gear 253 may be disposed between the second door-side gear 252 and the hinge gear 31. The third door-side gear 253 may be configured to transmit power transmitted to the second door-side gear 252 to the hinge gear 31. The hinge gear 31 may rotate by receiving power, and the door 30 may be opened and closed.

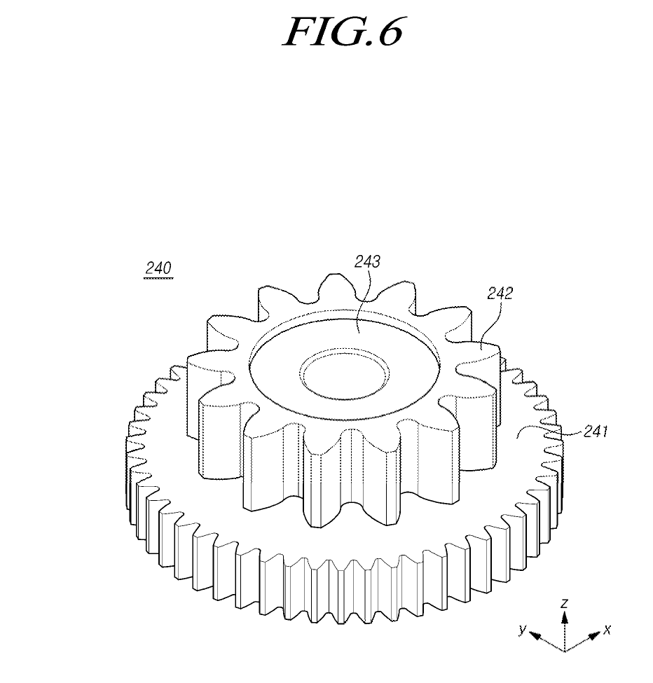

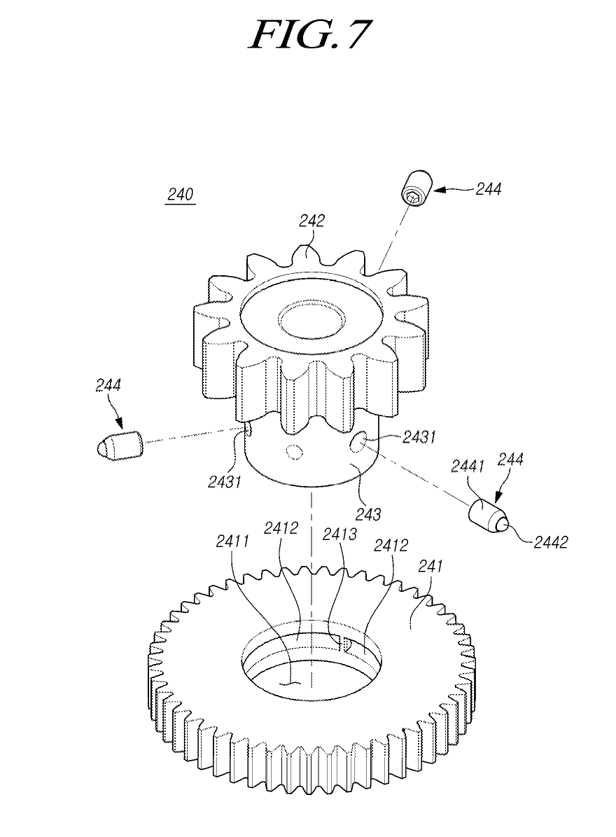

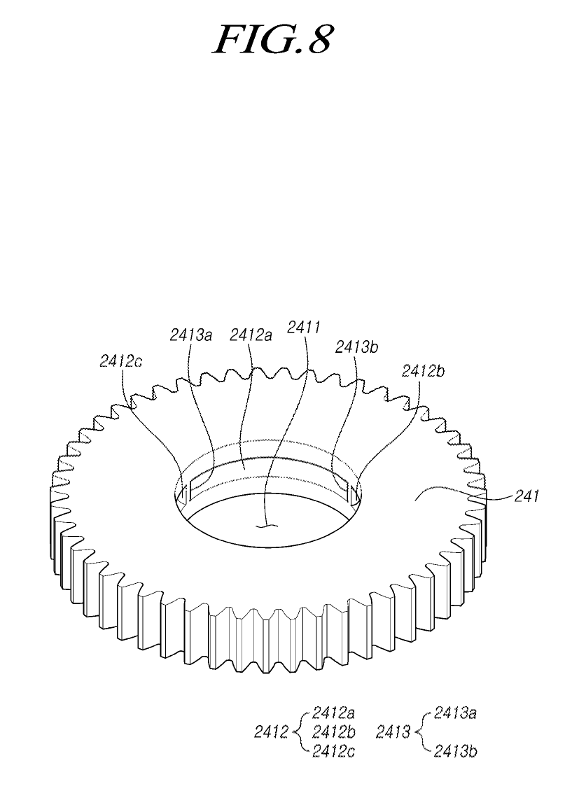

FIG. 6 is a view illustrating a clutch gear unit, according to an embodiment of the present disclosure. FIG. 7 is an exploded view illustrating a clutch gear unit, according to an embodiment of the present disclosure. FIG. 8 is a plan view illustrating a first clutch gear, according to an embodiment of the present disclosure.

The clutch gear unit 240 illustrated in FIGS. 6, 7, and 8 may be substantially identical or similar to the clutch gear unit 240 illustrated in FIGS. 3, 4, and 5. The clutch gear unit 240 illustrated in FIGS. 6, 7, and 8 may be included in the door opening and closing device 200 illustrated in FIGS. 1-5. Hereinafter, overlapping descriptions are omitted.

Referring to FIGS. 6, 7, and 8 the clutch gear unit 240 may include at least one of a first gear 241, a second gear 242, a rotation shaft 243, or an elastic body 244. In a case that the second gear 242 and the rotation shaft 243 are integrally formed, the rotation shaft 243 may be included in the second gear 242.

According to an example, the first gear 241 may include a hollow portion 2411. A portion of the second gear 242 may be drawn into the hollow portion 2411. For example, the rotation shaft 243 may be drawn into the hollow portion 2411. As the rotation shaft 243 is drawn into the hollow portion 2411, the first gear 241 and the second gear 242 may be stacked and disposed in a vertical direction.

According to an example, a diameter of the hollow portion 2411 may be larger than a diameter of the rotation shaft 243. In a state in which the rotation shaft 243 is drawn into the hollow portion 2411, the rotation shaft 243 and a surface of the hollow portion 2411 may not contact each other, or at least a portion thereof may be in contact.

According to an example, the first gear 241 and the second gear 242 may be coupled such that power is selectively transmittable by an elastic body 244 to be described below. The first gear 241 and the second gear 242 may be disposed such that power may not be transmitted to each other without coupling of the elastic body 244.

According to an example, the first gear 241 may include a groove portion 2412. The groove portion 2412 may be formed on an inner circumferential surface of the first gear 241. The groove portion 2412 may be formed on a surface of the hollow portion 2411. The groove portion 2412 may be recessedly formed to extend along a circumferential direction on the inner circumferential surface of the first gear 241. The groove portion 2412 may be recessedly formed to extend along a circumferential direction on the surface of the hollow portion 2411.

According to an example, the groove portion 2412 may be configured with a plurality. For example, the groove portion 2412 may include a first groove portion 2412a, a second groove portion 2412b, and a third groove portion 2412c. The first groove portion 2412a, the second groove portion 2412b, and the third groove portion 2412c may be spaced apart and disposed along a circumferential direction of the inner circumferential surface of the first gear 241. However, this is not limited thereto, and the number of groove portions 2412 may be at least one. Hereinafter, a case where the groove portion 2412 is configured with three is described as an example.

According to an example, the first groove portion 2412a, the second groove portion 2412b, and the third groove portion 2412c may have substantially identical circumferential lengths. However, embodiments of the disclosure are not limited thereto.

The groove portion 2412 may serve as a guide rail along which the elastic body 244 to be described below may move. In a case that the elastic body 244 moves within the groove portion 2412, power transmission between the first gear 241 and the second gear 242 may not occur.

According to an example, the first gear 241 may include a groove wall 2413. The groove wall 2413 may be located between two adjacent groove portions 2412. The groove wall 2413 may be configured with a plurality. For example, the groove wall 2413 may include a first groove wall 2413a, a second groove wall 2413b, and a third groove wall 2413c. However, this is not limited thereto, and the groove wall 2413 may be configured with at least one. Hereinafter, three illustrated groove walls are described as an example.

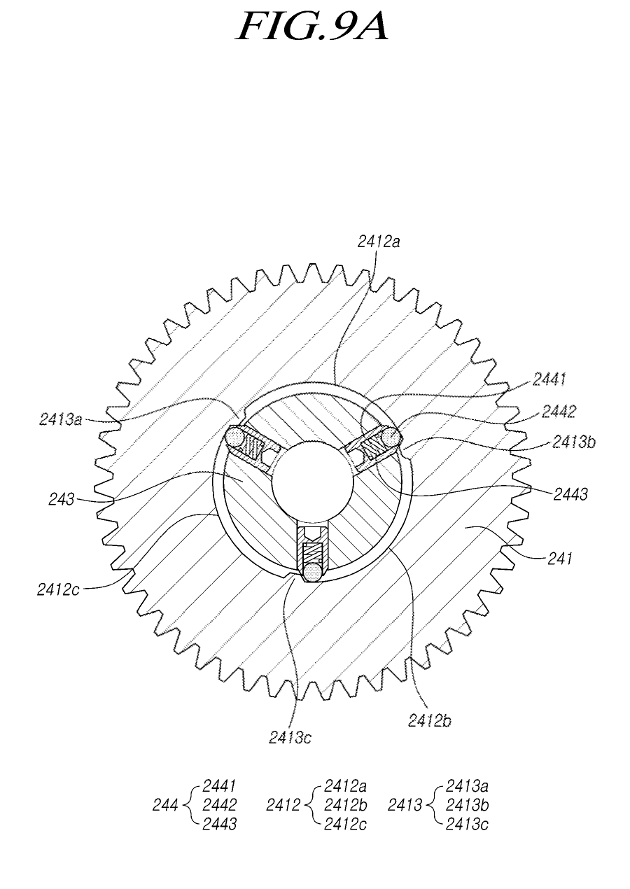

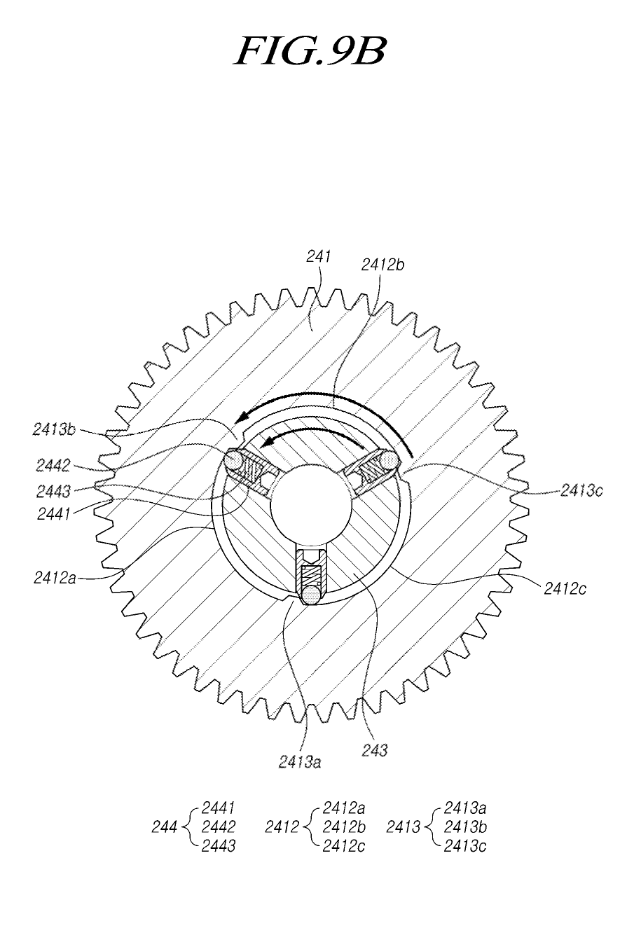

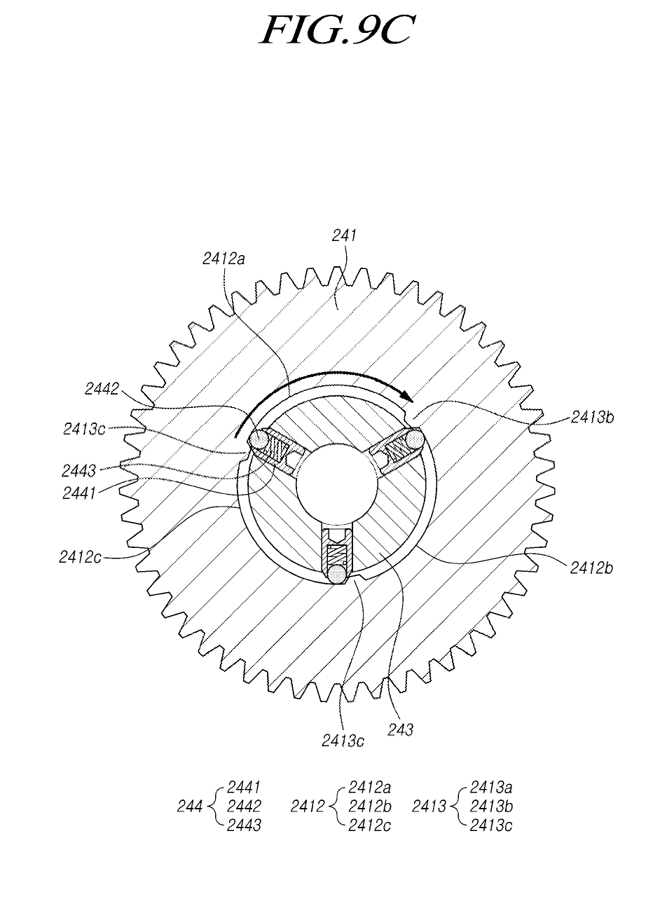

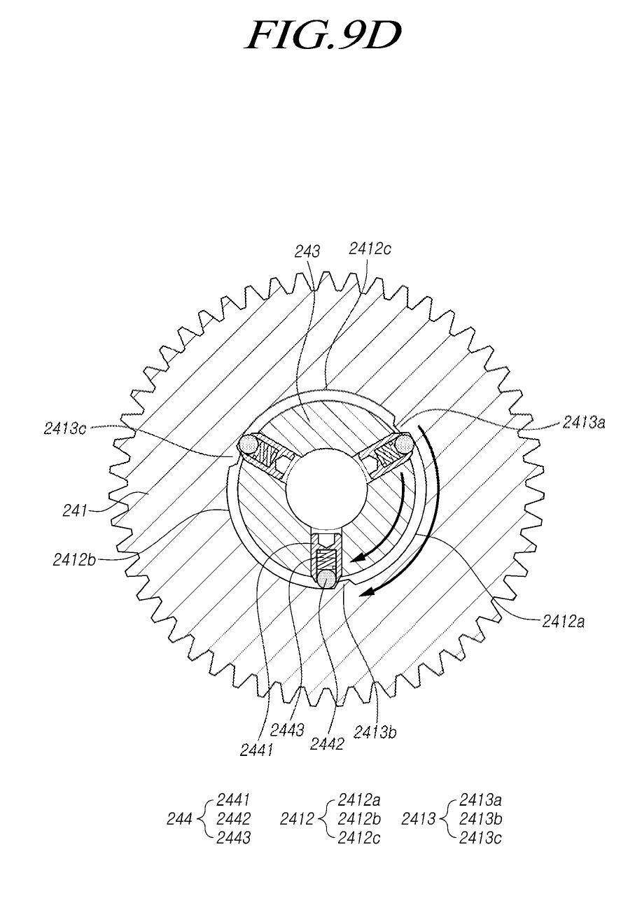

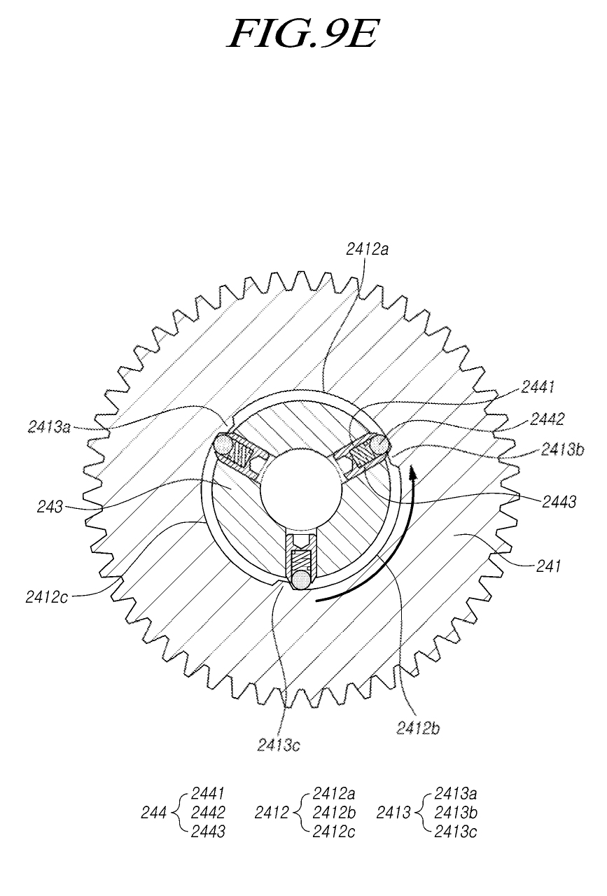

The first groove wall 2413a may be located, e.g., between the first groove portion 2412aand the third groove portion 2412c. The second groove wall 2413bmay be located, e.g., between the first groove portion 2412aand the second groove portion 2412b. The third groove wall (e.g., the third groove wall 2413c of FIG. 9A) may be located, e.g., between the second groove portion 2412band the third groove portion 2412c.

According to an example, the groove wall 2413 may be formed such that a portion of the elastic body 244 is caught on or in contact therewith. For example, the groove wall 2413 may be formed such that the head portion 2442 of the elastic body 244 is caught on or in contact therewith.

According to an example, the rotation shaft 243 may include an insertion groove 2431. The insertion groove 2431 may be formed such that the elastic body 244 is inserted therein. The body portion 2441 of the elastic body 244 may be drawn into the insertion groove 2431. The insertion groove 2431 may be formed such that the elastic body 244 is inserted toward a radial direction of the rotation shaft 243. The insertion groove 2431 may be provided in a number corresponding to the number of the elastic bodies 244.

According to an example, the elastic body 244 may be inserted into the insertion groove 2431 of the rotation shaft 243. The elastic body 244 may be inserted into the insertion groove 2431 such that the head portion 2442 faces a radially outward direction of the rotation shaft 243. At least a portion of the head portion 2442 of the elastic body 244 may be disposed to protrude from the rotation shaft 243. The elastic body 244 may be referred to as, e.g., a ball plunger or a spring plunger, but embodiments of the disclosure are not limited thereto.

According to an example, the elastic body 244 may include a body portion 2441, a head portion 2442, or a spring (e.g., the spring 2443 of FIG. 9A). The body portion 2441 may form an accommodation space therein.

A portion of the head portion 2442 may be received in the body portion 2441. The head portion 2442 may form an end of the elastic body 244. The head portion 2442 may be disposed such that a portion thereof protrudes to an outside of the body portion 2441. The head portion 2442 may be configured to move along the groove portion 2412 or to be caught on or in contact with the groove wall 2413. The head portion 2442 may be disposed to be movable relative to the body portion 2441. The head portion 2442 may have a ball shape, but embodiments of the disclosure are not limited thereto.

The spring 2443 may be received within the body portion 2441. The spring 2443 may be received to be compressed or extended along a length direction of the body portion 2441. Here, the length direction of the body portion 2441 may refer to a radial direction of the rotation shaft 243 in a case that the elastic body 244 is inserted into the rotation shaft 243. The spring 2443 may be configured such that one side thereof supports the head portion 2442.

The spring 2443 may be compressed or extended according to movement of the head portion 2442. For example, while the head portion 2442 passes through the groove wall 2413, the head portion 2442 may be moved in a direction compressing the spring 2443 (or a radially inward direction of the rotation shaft 243). In a case that the head portion 2442 passes through the groove wall 2413, the head portion 2442 may be moved radially outward of the rotation shaft 243 again by an elastic force of the spring 2443.

According to an example, the first gear 241 and the second gear 242 may be selectively capable of power transmission according to a relative position of the elastic body 244 with respect to the first gear 241. For example, in a case that the elastic body 244 moves along the groove portion 2412 while the first gear 241 receives power from the motor (e.g., the motor 220 of FIG. 3) and rotates, the power of the first gear 241 may not be transmitted to the second gear 242. For example, in a case that the elastic body 244 is caught on or in contact with the groove wall 2413 while the first gear 241 receives power from the motor 220 and rotates, the groove wall 2413 of the first gear 241 may press the head portion 2442 of the elastic body 244, and the power of the first gear 241 may be transmitted to the second gear 242.

For example, in a case that the door (e.g., the door 30 of FIG. 1) is rotated by manual operation of the user, the second gear 242 receiving power from the hinge gear 31 may be rotated. In a case that the elastic body 244 moves along the groove portion 2412 while the second gear 242 is rotated, the power of the second gear 242 may not be transmitted to the first gear 241.

FIGS. 9A-9E are views illustrating an operation of a clutch gear unit during an automatic door opening and closing operation, according to an embodiment of the present disclosure.

FIGS. 9A-9E are cross-sectional views illustrating a state in which the first gear 241 and the rotation shaft 243 are cut across in the clutch gear unit (e.g., the clutch gear unit 240 of FIG. 6).

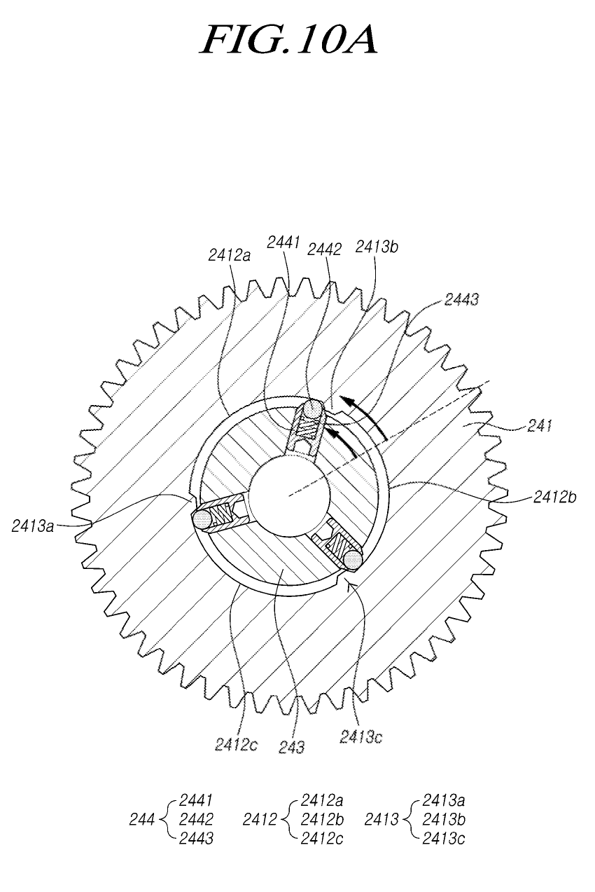

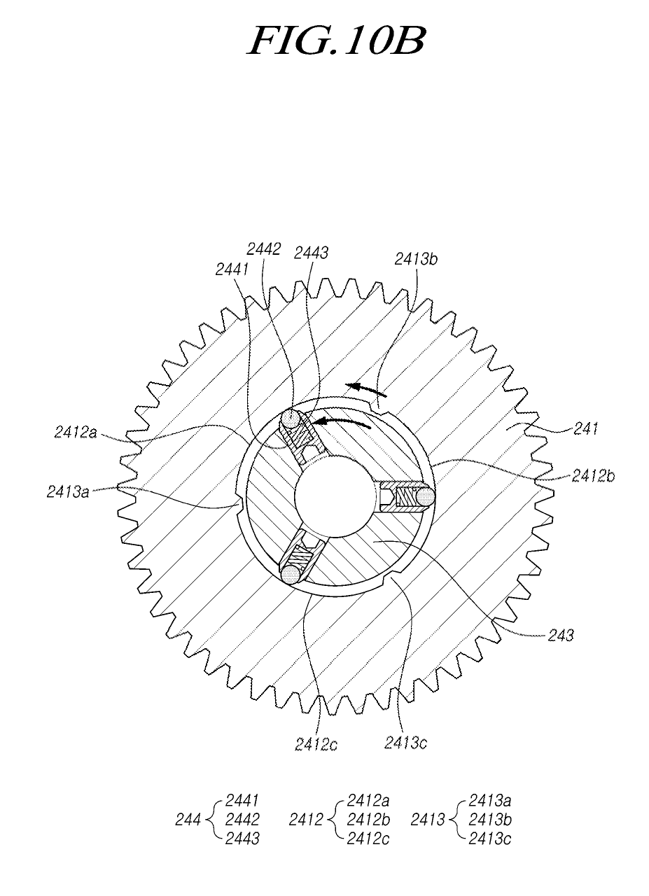

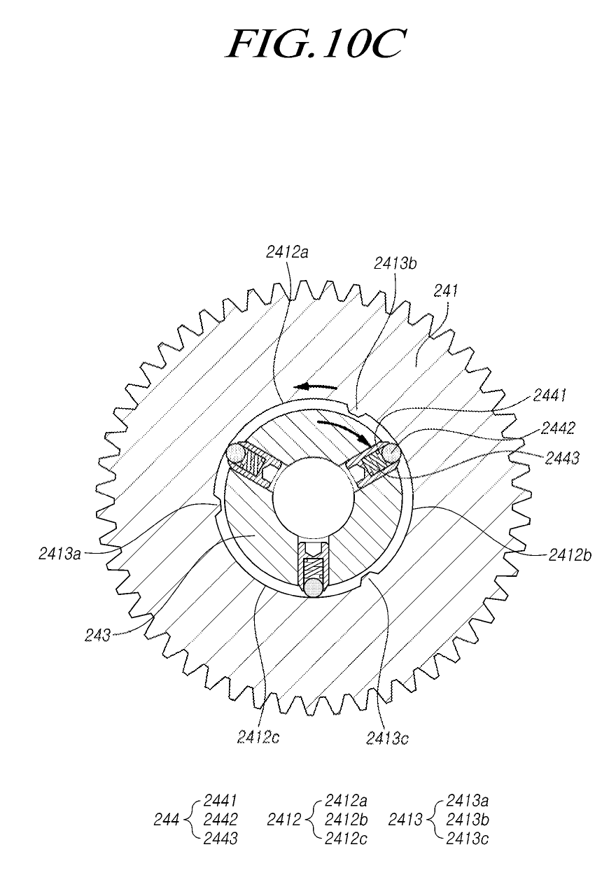

The embodiment of FIGS. 9A-9E may be selectively combined with the embodiment of FIGS. 1-8. The embodiment of FIGS. 9A-9E may be selectively combined with the embodiment of FIGS. 10A-19.

FIGS. 9A-9E are views specifically describing an operation of the clutch gear unit 240 in a process in which the door opening and closing device (e.g., the door opening and closing device 200 of FIG. 1) operates to open or close the door (e.g., the door 30 of FIG. 1). Hereinafter, for convenience of description, the clutch gear unit 240 provided with three elastic bodies 244, three groove portions 2412, and three groove walls 2413 is described as an example, but this is an example and the number of each component does not limit the scope of the disclosure.

FIG. 9A is a view illustrating a coupling structure of the clutch gear unit 240 in a state in which the door 30 is closed. Referring to FIG. 9A, the door 30 may be prepared to open in a state in which the elastic body 244 is caught on or in contact with the groove wall 2413 of the first gear 241.

FIG. 9B is a view illustrating an operation of the clutch gear unit 240 while the door 30 is being opened. Referring to FIG. 9B, the motor (e.g., the motor 220 of FIG. 3) may be driven, and the first gear 241 and the second gear 242 may be rotated in a first direction. The first gear 241 receiving power from the motor 220 is rotated in the first direction, and in a state in which the groove wall 2413 contacts the elastic body 244, the groove wall 2413 presses the elastic body 244, and the rotation shaft 243 may be rotated. As the rotation shaft 243 is rotated in the first direction, the second gear 242 is also rotated together in the first direction, and as a result, the door 30 may be automatically opened. Here, the first direction may be a counterclockwise direction in the drawings. However, this is not limited thereto, and the first direction for opening the door 30 may be a clockwise direction. In the present disclosure, a case where the first direction is a counterclockwise direction is described as an example for convenience of description.

FIG. 9C is a view illustrating an operation for preparing a door closing operation after the opening of the door 30 is completed. After the opening of the door 30 is completed, in order to prepare for door closing, the motor 220 may be driven to rotate the first gear 241 in a second direction. The first gear 241 may be rotated until the groove wall 2413 contacts another adjacent elastic body 244. While the first gear 241 is rotated in the second direction, since the elastic body 244 is located within the groove portion 2412, the power of the first gear 241 may not be transmitted to the rotation shaft 243. Here, the second direction may be a clockwise direction in the drawings. However, this is not limited thereto and, in a case that the first direction is a clockwise direction, the second direction may be a counterclockwise direction.

FIG. 9D is a view illustrating an operation of the clutch gear unit 240 while the door 30 is being closed. Referring to FIG. 9C, the motor 220 may be driven, and the first gear 241 and the second gear 242 may be rotated in a second direction. The first gear 241 receiving power from the motor 220 is rotated in the second direction, and in a state in which the groove wall 2413 contacts the elastic body 244, the groove wall 2413 presses the elastic body 244, and the rotation shaft 243 may be rotated. As the rotation shaft 243 is rotated in the second direction, the second gear 242 is also rotated together in the second direction, and as a result, the door 30 may be automatically closed.

FIG. 9E is a view illustrating an operation for preparing a door opening operation after the door 30 is closed. After the closing of the door 30 is completed, in order to prepare for door opening, the motor 220 may be driven to rotate the first gear 241 in a first direction. The first gear 241 may be rotated until the groove wall 2413 contacts another adjacent elastic body 244. While the first gear 241 is rotated in the first direction, since the elastic body 244 is located within the groove portion 2412, the power of the first gear 241 may not be transmitted to the rotation shaft 243.

The operation process illustrated in FIGS. 9A-9E is illustrating an operation of the clutch gear unit 240 in the disclosure, and embodiments of the disclosure are not limited to the illustrated operation sequence.

FIGS. 10A-10C are views illustrating an operation of a clutch gear unit in a circumstance where a door opening and closing operation is switched from automatic to manual, according to an embodiment of the present disclosure.

FIGS. 10A-10C are cross-sectional views illustrating a state in which the first gear 241 and the rotation shaft 243 are cut across in the clutch gear unit (e.g., the clutch gear unit 240 of FIG. 6).

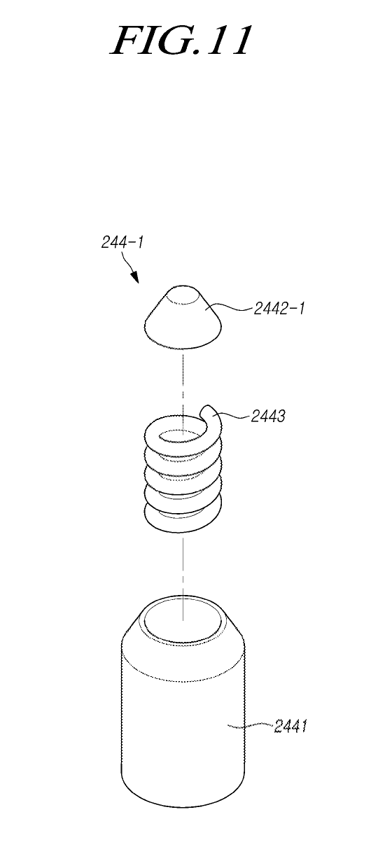

The embodiment of FIGS. 10A-10C may be selectively combined with the embodiment of FIGS. 1-9E. The embodiment of FIGS. 10A-10C may be selectively combined with the embodiment of FIGS. 11-19.

FIGS. 10A-10C are views specifically describing an operation of the clutch gear unit 240 in a process in which the door opening and closing device (e.g., the door opening and closing device 200 of FIG. 1) operates to open or close the door (e.g., the door 30 of FIG. 1). Hereinafter, for convenience of description, the clutch gear unit 240 provided with three elastic bodies 244, three groove portions 2412, and three groove walls 2413 is described as an example, but this is an example and the number of each component does not limit the scope of the disclosure.

FIG. 10A illustrates an arbitrary point during a process in which the door 30 is being opened in the door opening and closing device (e.g., the door opening and closing device 200 of FIG. 1). For example, FIG. 10A is a view illustrating a state in which the first gear 241 and the rotation shaft 243 have been rotated in a first direction by a predetermined distance from the state of FIG. 9A.

FIG. 10B is a view illustrating an operation in a case that an external force acts in the same direction as the rotation direction of the first gear 241 of FIG. 10A. Here, the external force may include, e.g., an external force due to the user’s operation of the door (e.g., the door 30 of FIG. 1). In a case that an external force acts in the same direction as the rotation direction of the first gear 241, the hinge gear (e.g., the hinge gear 31 of FIG. 2) provided on the door 30 rotates, and the rotation of the hinge gear 31 is transmitted to the second gear 242, and the second gear 242 may have a faster rotation speed than the first gear 241. In this case, the elastic body 244 rotating together with the second gear 242 moves along the groove portion 2412 as illustrated, and thus the power due to the rotation of the second gear 242 may not be transmitted to the first gear 241. Therefore, even in a case that an external force by the user is applied, a load is not applied to the motor 220, thereby preventing performance degradation or failure of the motor 220.

Even in a case that the user applies an external force and the second gear 242 rotates faster than the first gear 241, the motor 220 may rotate the first gear 241 by performing a predetermined operation without stopping.

As an example, assuming a circumstance where the door 30 opens in a case that the first gear 241 and the rotation shaft 243 are rotated in the first direction, the external force in FIG. 10B may refer to an additional force with which the user directly opens the door 30.

As an example, assuming a circumstance where the door 30 closes in a case that the first gear 241 and the rotation shaft 243 are rotated in the first direction, the external force in FIG. 10B may refer to an additional force with which the user directly closes the door 30.

FIG. 10C is a view illustrating an operation in a case that an external force acts in a direction opposite to the rotation direction of the first gear 241 of FIG. 10A.

In a case that an external force acts in a direction opposite to the rotation direction of the first gear 241, the hinge gear 31 provided on the door 30 rotates, and the rotation of the hinge gear 31 is transmitted to the second gear 242, and the second gear 242 may be rotated in a second direction opposite to the first direction. In order for the second gear 242 to rotate in the opposite direction to the first gear 241, the groove wall 2413 in contact with the elastic body 244 should be passed, and thus the magnitude of the external force should be a force sufficient enough for the elastic body 244 to pass through the groove wall 2413. Since the head portion 2442 of the elastic body 244 is movable in a radial direction of the rotation shaft 243, the elastic body 244 may pass through the groove wall 2413 in a case that a sufficient force is applied. After the elastic body 244 passes through the groove wall 2413, the elastic body 244 may move along another adjacent groove portion 2412. Here, a force required for the head portion 2442 to pass through the groove wall 2413 may be referred to as a clutch switching load. For example, as the magnitude of the clutch switching load increases, the magnitude of the force required for the head portion 2442 to pass through the groove wall 2413 may increase.

According to an example, the magnitude of the clutch switching load may be adjusted by adjusting a depth where the elastic body 244 is inserted into the insertion groove 2431 of the rotation shaft 243. For example, as the elastic body 244 is inserted deeper into the insertion groove 2431 of the rotation shaft 243, the magnitude of the clutch switching load may decrease.

While the elastic body 244 moves along another adjacent groove portion 2412, the rotational power of the second gear 242 is not transmitted to the first gear 241, and thus a load may be prevented from being applied to the motor 220 by reverse rotation. As such, even in a case that an external force acting to rotate the second gear 242 in a direction opposite to the rotation direction of the first gear 241 is applied, the motor 220 may still rotate the first gear 241 in the first direction. The motor 220 may rotate the first gear 241 in the first direction until the groove wall 2413 contacts the elastic body 244. Since an operation of the motor 220 does not change even in a case that the user operates the door 30, there is no need to detect reverse rotation using a current load or the like in the disclosure. In the disclosure, using the structure of the clutch gear unit 240, even in a case that a transition is made from automatic opening and closing of the door 30 to manual opening and closing, a load applied to the motor 220 may be prevented without changing an operation of the motor 220.

As an example, assuming a circumstance where the door 30 opens in a case that the first gear 241 and the rotation shaft 243 are rotated in the first direction, the external force in FIG. 10C may refer to an additional force with which the user directly closes the door 30.

As an example, assuming a circumstance where the door 30 closes in a case that the first gear 241 and the rotation shaft 243 are rotated in the first direction, the external force in FIG. 10C may refer to an additional force with which the user directly opens the door 30.

FIG. 11 is a view illustrating an elastic body, according to an embodiment of the present disclosure.

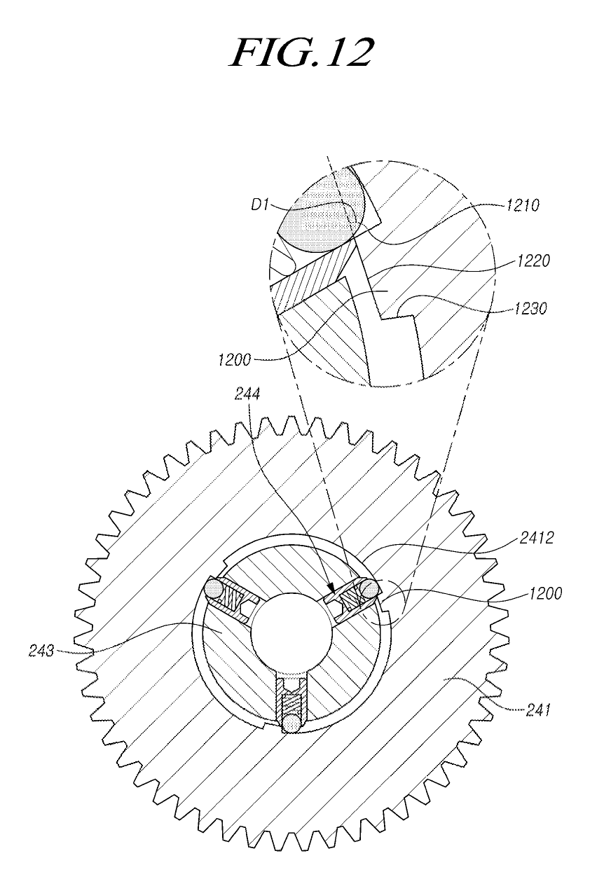

The embodiment of FIG. 11 may be selectively combined with the embodiment of FIGS. 1-10C. The embodiment of FIG. 11 may be selectively combined with the embodiment of FIGS. 12-19.

The elastic body 244-1 illustrated in FIG. 11 may be included in the clutch gear unit (e.g., the clutch gear unit 240 of FIG. 7) by replacing the elastic body (e.g., the elastic body 244 of FIG. 7). The same reference numerals are used for components substantially identical to the elastic body (e.g., the elastic body 244 of FIG. 7) among the components of the elastic body 244-1 illustrated in FIG. 11.

According to an example, the elastic body 244-1 may include a body portion 2441, a head portion 2442-1, and a spring 2443.

According to an example, the head portion 2442-1 may have a substantially truncated cone shape. By having a truncated cone shape instead of a ball shape, a force required for the head portion 2442-1 to pass through the groove wall (e.g., the groove wall 2413 of FIG. 7) may be increased. Here, a force required for the head portion 2442-1 to pass through the groove wall 2413 may be referred to as a clutch switching load.

For example, by adjusting a shape of the head portion 2442-1, a magnitude of a force required for the second gear (e.g., the second gear 242 of FIG. 7) to rotate in a direction opposite to the rotation direction of the first gear (e.g., the first gear 241 of FIG. 7) may be increased. For example, the magnitude of the clutch switching load may be increased by modifying a shape of the head portion 2442-1 as illustrated.

The head portion 2442-1 may have a shape of a cube with tapered corner portions as well as a truncated cone shape. In the case of a cube, a degree of tapering may be adjusted.

FIG. 12 is a cross-sectional view illustrating a clutch gear unit, according to an embodiment of the present disclosure.

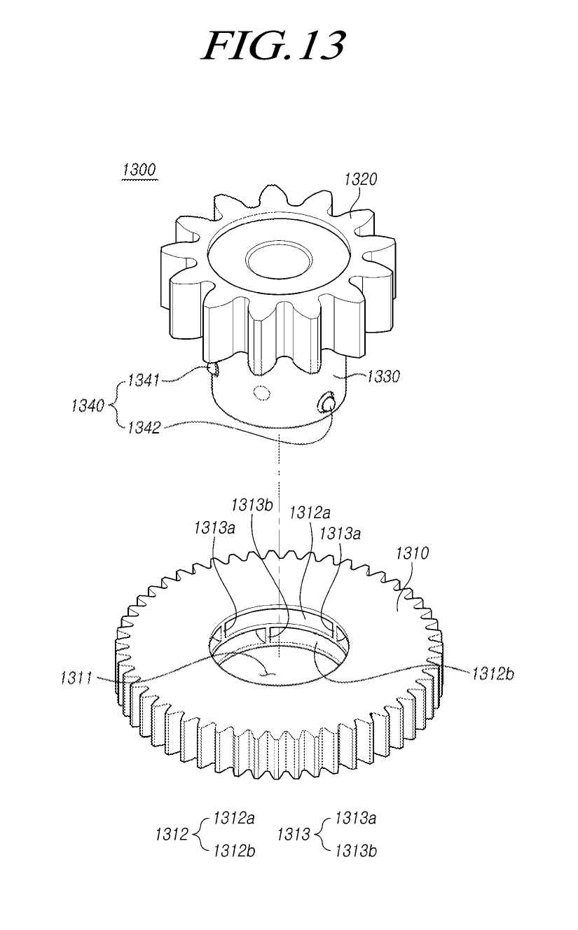

The embodiment of FIG. 12 may be selectively combined with the embodiment of FIGS. 1-11. The embodiment of FIG. 12 may be selectively combined with the embodiments of FIGS. 13-19.

FIG. 12 is a view illustrating a modified shape of a groove wall 1200. The same reference numerals are used for components substantially identical or similar to the above-described components among the illustrated components.

Referring to FIG. 12, the first gear 241 may include a groove wall 1200. The groove wall 1200 may include a first side surface 1210, an upper surface 1220 extending from the first side surface 1210, and a second side surface 1230 extending from the upper surface 1220 and located on an opposite surface of the first side surface 1210.

According to an example, a clutch switching load may be adjusted by adjusting a magnitude of an angle D1 formed by extension lines of the first side surface 1210 and the upper surface 1220. For example, as the magnitude of the angle D1 increases, the clutch switching load may increase. As an example, the angle D1 may be 90 degrees, but embodiments of the disclosure are not limited thereto.

The clutch gear unit 240 according to various embodiments of the disclosure may adjust the magnitude of the clutch switching load by adjusting shapes of the head portion 2442 of the elastic body 244 and the groove wall 2413 of the first gear 241 as described in connection to FIGS. 11 and 12.

FIG. 13 is a view illustrating a clutch gear unit, according to an embodiment of the present disclosure.

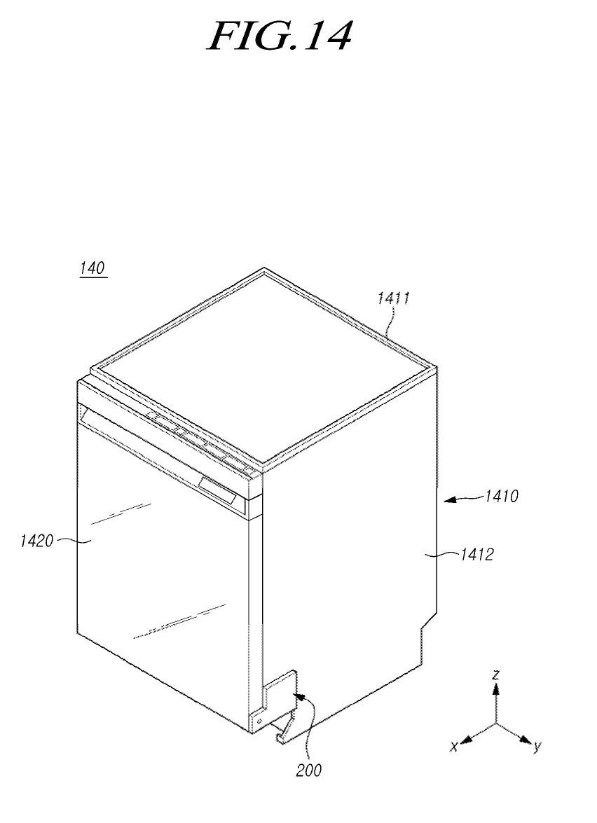

The embodiment of FIG. 13 may be selectively combined with the embodiment of FIGS. 1-12. The embodiment of FIG. 13 may be selectively combined with the embodiments of FIGS. 14 -19.

The clutch gear unit 1300 illustrated in FIG. 13 may replace the clutch gear unit (e.g., the clutch gear unit 240 of FIG. 4) illustrated in FIG. 4. For example, the clutch gear unit 1300 illustrated in FIG. 13 may be included in the door opening and closing device (e.g., the door opening and closing device 200 of FIG. 4) of FIG. 4.

Referring to FIG. 13, the clutch gear unit 1300 may include at least one of a first gear 1310, a second gear 1320, a rotation shaft 1330, or an elastic body 1340. In a case that the second gear 1320 and the rotation shaft 1330 are integrally formed, the rotation shaft 1330 may be included in the second gear 1320.

According to an example, the first gear 1310 may include a hollow portion 1311. A portion of the second gear 1320 may be drawn into the hollow portion 1311. For example, the rotation shaft 1330 may be drawn into the hollow portion 1311. As the rotation shaft 1330 is drawn into the hollow portion 1311, the first gear 1310 and the second gear 1320 may be stacked and disposed in a vertical direction.

According to an example, a diameter of the hollow portion 1311 may be larger than a diameter of the rotation shaft 1330. In a state in which the rotation shaft 1330 is drawn into the hollow portion 1311, the rotation shaft 1330 and a surface of the hollow portion 1311 may not contact each other.

According to an example, the first gear 1310 and the second gear 1320 may be coupled such that power is selectively transmittable by an elastic body 1340 to be described below.

According to an example, the first gear 1310 may include a groove portion 1312. The groove portion 1312 may be formed on an inner circumferential surface of the first gear 1310. The groove portion 1312 may be formed on a surface of the hollow portion 1311. The groove portion 1312 may be recessedly formed to extend along a circumferential direction on the inner circumferential surface of the first gear 1310. The groove portion 1312 may be recessedly formed to extend along a circumferential direction on the surface of the hollow portion 1311.

According to an example, the groove portion 1312 may include an upper groove portion 1312aand a lower groove portion 1312b. The upper groove portion 1312a and the lower groove portion 1312b may be spaced apart from each other and disposed in a vertical direction. Here, the vertical direction may refer to an axial direction of the rotation shaft 1330. For example, the upper groove portion 1312amay be configured with a plurality. For example, the lower groove portion 1312bmay be configured with a plurality. According to an example, the upper groove portion 1312a and the lower groove portion 1312b may have substantially identical circumferential lengths. However, embodiments of the disclosure are not limited thereto.

The groove portion 1312 may serve as a guide rail along which the elastic body 1340 to be described below may move. In a case that the elastic body 1340 moves within the groove portion 1312, power transmission between the first gear 1310 and the second gear 1320 may not occur.

In the drawings, an example in which the upper groove portion 1312a and the lower groove portion 1312b form two layers vertically is illustrated, but this is an example and embodiments of the disclosure are not limited thereto. For example, an additional groove portion may be provided to form three or more layers.

According to an example, the first gear 1310 may include a groove wall 1313. The groove wall 1313 may be located between two adjacent groove portions 1312. The groove wall 1313 may be configured with a plurality.

According to an example, the groove wall 1313 may include an upper groove wall 1313a and a lower groove wall 1313b. The upper groove wall 1313aand the lower groove wall 1313b may be spaced apart from each other and disposed in a vertical direction. Here, the vertical direction may refer to an axial direction of the rotation shaft 1330. For example, the upper groove wall 1313a may be configured with a plurality. For example, the lower groove wall 1313bmay be configured with a plurality.

According to an example, the groove wall 1313 may be formed such that a portion of the elastic body 1340 is caught on or in contact therewith. For example, the groove wall 1313 may be formed such that a head portion of the elastic body 1340 is caught on or in contact therewith.

According to an example, the elastic body 1340 may be inserted into the rotation shaft 1330. The elastic body 1340 may be inserted into the rotation shaft 1330 such that a head portion faces a radially outward direction of the rotation shaft 1330. The elastic body 1340 may be referred to as, e.g., a ball plunger or a spring plunger, but embodiments of the disclosure are not limited thereto.

According to an example, the first gear 1310 and the second gear 1320 may be selectively capable of power transmission according to a relative position of the elastic body 1340 with respect to the first gear 1310. For example, in a case that the elastic body 1340 moves along the groove portion 1312 while the first gear 1310 receives power from the motor (e.g., the motor 220 of FIG. 3) and rotates, the power of the first gear 1310 may not be transmitted to the second gear 1320. For example, in a case that the elastic body 1340 is caught on or in contact with the groove wall 1313 while the first gear 1310 receives power from the motor 220 and rotates, the groove wall 1313 of the first gear 1310 may press a portion of the elastic body 1340, and the power of the first gear 1310 may be transmitted to the second gear 1320.

For example, in a case that the door (e.g., the door 30 of FIG. 1) is rotated by manual operation of the user, the second gear 1320 receiving power from the hinge gear (e.g., the hinge gear 31 of FIG. 3) may be rotated. In a case that the elastic body 1340 moves along the groove portion 1312 while the second gear 1320 is rotated, the power of the second gear 1320 may not be transmitted to the first gear 1310.

According to an example, the elastic body 1340 may include an upper elastic body 1341 and a lower elastic body 1342. The upper elastic body 1341 and the lower elastic body 1342 may be spaced apart from each other and disposed in a vertical direction. The upper elastic body 1341 and the lower elastic body 1342 may be disposed on different horizontal planes. For example, the upper elastic body 1341 may be configured with a plurality. For example, the lower elastic body 1342 may be configured with a plurality.

As illustrated, by disposing more elastic bodies 1340 in a vertical direction, a clutch switching load may be increased.

In the drawings, an example in which the upper elastic body 1341 and the lower elastic body 1342 form two layers vertically is illustrated, but this is an example and embodiments of the disclosure are not limited thereto. For example, an additional elastic body may be provided to form three or more layers in order to increase the clutch switching load.

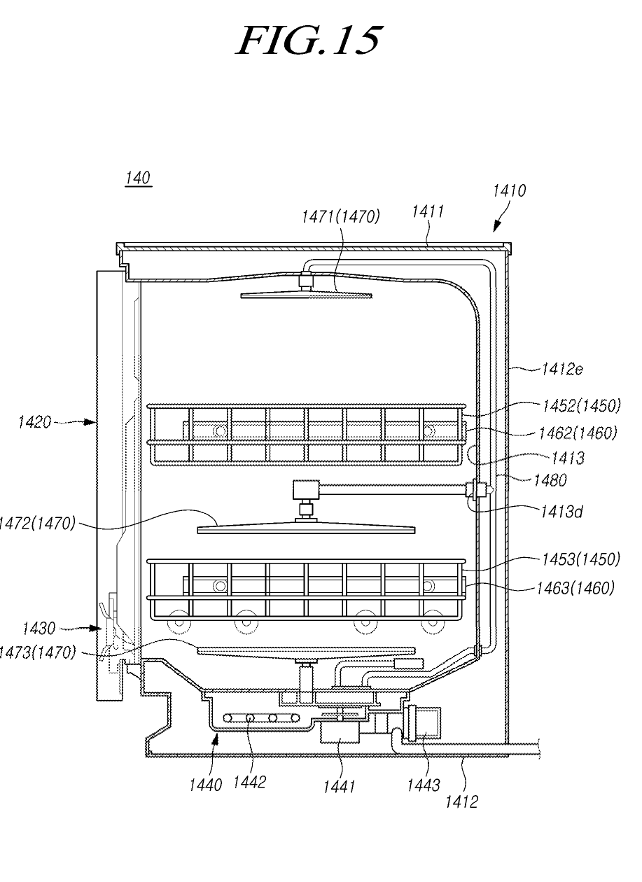

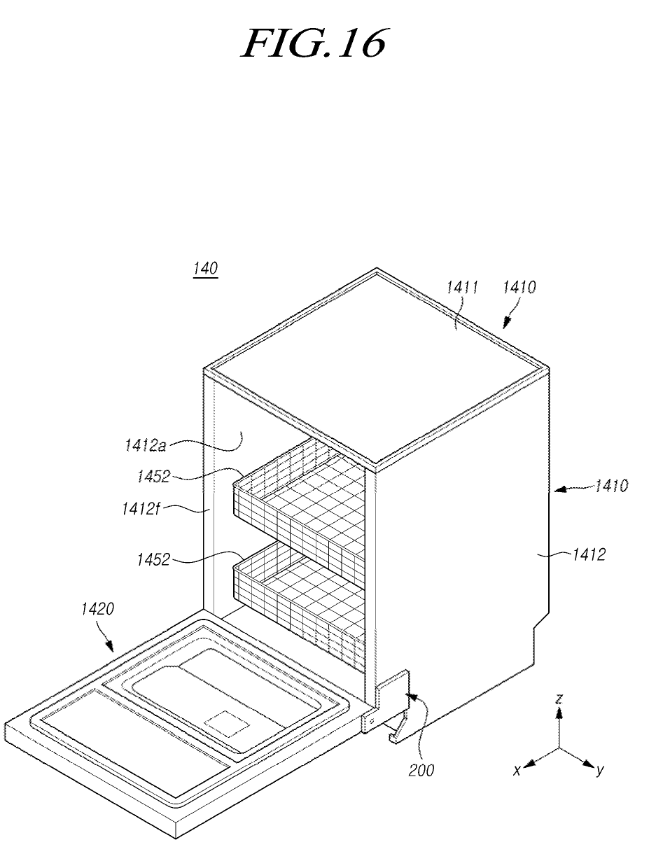

FIG. 14 is a perspective view illustrating a dishwasher, according to an embodiment of the present disclosure. FIG. 15 is a side cross-sectional view illustrating a dishwasher, according to an embodiment of the present disclosure. FIG. 16 is a perspective view illustrating a state in which a door is opened in a dishwasher, according to an embodiment of the present disclosure.

FIGS. 14, 15, and 16 illustrate views illustrating a dishwasher as an example of a home appliance.

The embodiment of FIGS. 14, 15, and 16 may be selectively combined with the embodiment of FIGS. 3-13.

Referring to FIGS. 14-16, a dishwasher 140 may include a body 1410. The body 1410 may include a cabinet 1412 forming an exterior, a tub 1413 disposed inside the body 1410 and forming a washing chamber 1420, and a door 1414 installed on the cabinet 1412 and provided to open and close the tub 1413. However, the dishwasher 140 may be provided in a built-in form, and in this case, the cabinet 1412 may be omitted.

The cabinet 1412 may be provided in an approximately box shape. One surface of the cabinet 1412 may be open. In other words, the cabinet 1412 may have an opening 1412a. As an example, a front surface of the cabinet 1412 may be open.

The cabinet 1412 and the tub 1413 are provided in an about hexahedral shape with one surface open. The body 1410 may include an upper cover 1411 provided on an upper side of the cabinet 1412.

The cabinet 1412 may include a rear panel 1412e, both side panels 1412c, 1412d extending from one side and the other side of a front of the rear panel 1412e, and a front panel 1412f formed by being bent from the both side panels 1412c, 1412d. The front panel 1412fmay be provided to form an opening 1412ain a front of the cabinet 1412. A door 1414 may be provided to open and close the opening 1412aof the front panel 1412f.

In an embodiment of the disclosure, the front panel 1412f is illustrated as being integrally extending from the both side panels 1412c, 1412d, but embodiments of the disclosure are not limited thereto.

The door 1414 may be rotatably installed on the cabinet 1412. The door 1414 may be hinge-coupled to the cabinet 1412 to be rotatable at a lower end of the cabinet 1412. The door 1414 may be coupled to the cabinet 1412 by a hinge device 1430.

Inside the cabinet 1412, a sump unit 1440 disposed at a lower portion of the tub 1413 and collecting water used for washing, a plurality of baskets 1450 disposed to be withdrawable from an inside of the cabinet 1412 to an outside and on which dishes are disposed, a guide rack 1460 supporting the plurality of baskets 1450, and a plurality of spray nozzles 1471, 1472, 1473 spraying water delivered from the sump unit 1440 toward dishes disposed in the plurality of baskets 1450 may be disposed.

Dishes having a relatively large volume may be stored in the plurality of baskets 1450. A type and size of dishes stored in the plurality of baskets 1450 are not limited. A type of dishes stored in the plurality of baskets 1450 may include dishes having a relatively large or small volume.

The plurality of baskets 1450 may include a first basket 1451, a second basket 1452, and a third basket 1453. The first basket 1451 may be coupled to the tub 1413 at an upper portion of the tub 1413 to be disposed on an upper side of the second basket 1452 and the third basket 1453. The first basket 1451 may be located on an upper side of the second basket 1452. The second basket 1452 may be coupled to the tub 1413 at an intermediate portion of the tub 1413 to be disposed on a lower side of the first basket 1451 and/or an upper side of the third basket 1453. The third basket 1453 may be coupled to the tub 1413 at a lower portion of the tub 1413 to be disposed on a lower side of the first and second baskets 1451, 1452. The first basket 1451 may be a sub basket 1451 in which dishes having a relatively small volume are stored. Small cups such as espresso cups may be stored in the sub basket 1451. However, a type of dishes stored in the sub basket 1451 is not limited to the example.

The dishwasher 140 may include a first guide rack 1461 provided such that the first basket 1451 is supported within the tub 1413, a second guide rack 1462 provided such that the second basket 1452 is supported, and a third guide rack 1463 provided such that the third basket 1453 is supported. The guide racks 1461, 1462, 1463 may be rails for withdrawing the baskets 1451, 1452, 1453, respectively.

The first guide rack 1461, the second guide rack 1462, and the third guide rack 1463 may be installed on inner walls 1413b, 1413c of the tub 1413 such that the first basket 1451, the second basket 1452, and the third basket 1453 are slidable toward a front surface of the tub 1413. For example, the guide rack 1460 may be installed on a left wall 1413band a right wall 1413c of the tub 1413.

Along the first guide rack 1461, the second guide rack 1462, and the third guide rack 1463, the first basket 1451, the second basket 1452, and the third basket 1453 may slide in a forward/backward direction of the tub 1413.

The sump unit 1440 may be disposed at a lower center of the cabinet 1412 and may serve to collect washing water used for washing. The sump unit 1440 may be provided with a washing pump 1441 pumping stored water to a spray unit 1470. Washing water pumped by the washing pump 1441 may be supplied to a first spray nozzle 1471, a second spray nozzle 1472, and a third spray nozzle 1473 through a supply pipe 1480.

The dishwasher 140 may further include a washing water heater 1442 disposed at a lower portion of the cabinet 1412 to heat washing water, and a drain pump 1443 disposed at a lower portion of the tub 1413 to drain washing water.

The dishwasher 140 may include a spray unit 1470 provided to spray washing water. The spray unit 1470 may include a first spray nozzle 1471 disposed on an upper side of the first basket 1451, a second spray nozzle 1472 disposed on an upper side of the first basket 1451 and the second basket 1452, i.e., between the second basket 1452 and the third basket 1453, and a third spray nozzle 1473 disposed at a lower portion of the third basket 1453.

The first spray nozzle 1471 is provided to be rotatable. The first spray nozzle 1471 may spray washing water toward dishes stored in the first basket 1451 and/or the second basket 1452. The second spray nozzle 1472 is provided to be rotatable. The second spray nozzle 1472 is provided to spray washing water toward dishes stored in the second basket 1452 and the third basket 1453. The third spray nozzle 1473 is provided to be rotatable. The third spray nozzle 1473 is provided to spray washing water toward dishes stored in the third basket 1453.

According to an example, the dishwasher 140 may include a door opening and closing device 200. The door opening and closing device 200 may refer to a device configured to automatically open and close the door 1414 by driving a motor according to an external input, rather than the user directly operating to open or close the door 1414. Here, the door opening and closing device 200 is substantially identical or similar to the door opening and closing device 200 described in connection to FIGS. 4-13. Since driving and operation of the door opening and closing device 200 have been specifically described in connection to FIGS. 4-13, the description is omitted hereinafter.

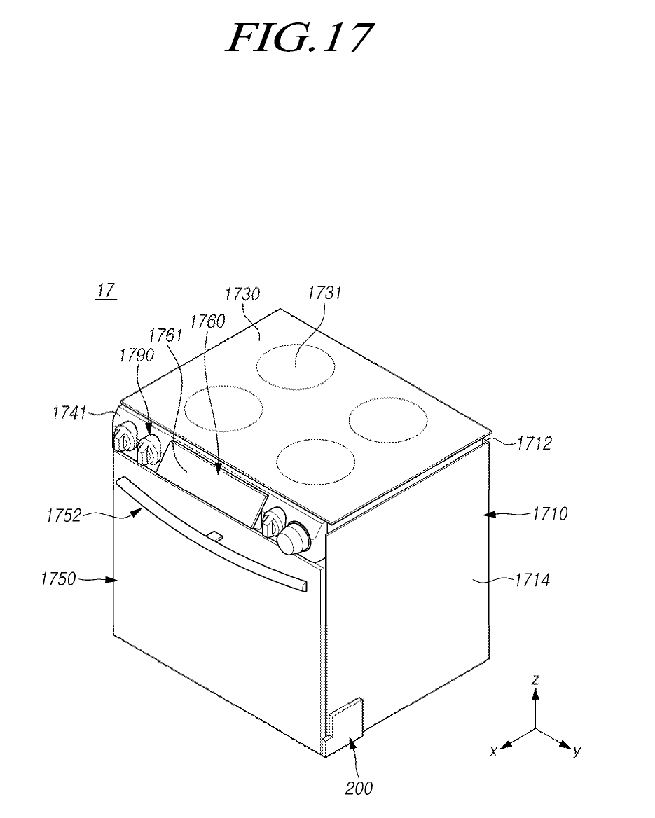

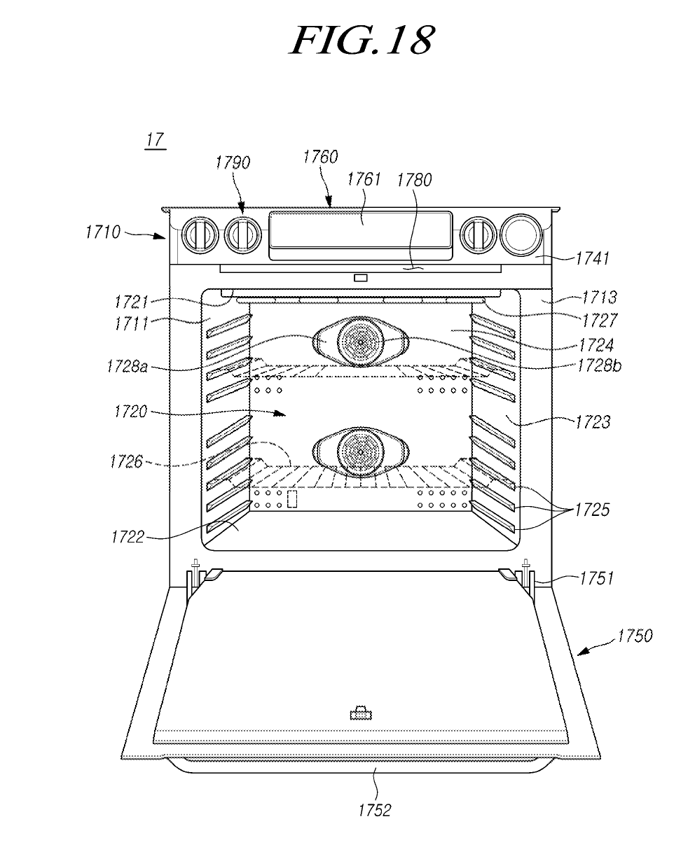

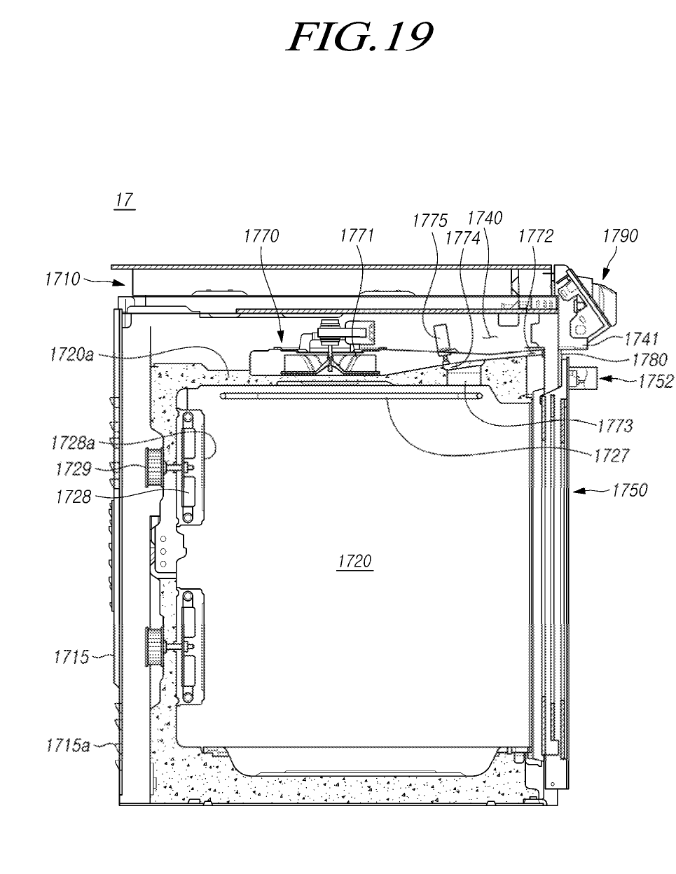

FIG. 17 is a perspective view illustrating a cooking device, according to an embodiment of the present disclosure. FIG. 18 is a view illustrating a state in which a door of a cooking device is opened, according to an embodiment of the present disclosure. FIG. 19 is a side cross-sectional view illustrating a cooking device, according to an embodiment of the present disclosure.

FIGS. 17, 18, and 19 illustrate views illustrating an oven as an example of a cooking device or an example of a home appliance.

The embodiment of FIGS. 17, 18, and 19 may be selectively combined with the embodiment of FIGS. 3-13.

Referring to FIGS. 17, 18, and 19, a cooking device 17 may be a device in which an oven and a cooktop 1730 located on an upper portion of the oven are combined or integrally formed. However, this is an example drawing for description, and the cooktop 1730 may be excluded from an upper portion of the oven.

In the cooking device 17 in which the cooktop 1730 and the oven are vertically combined, the cooktop 1730 and the oven may have various types of heating source combinations. For example, the cooktop 1730 may be provided with an electric or gas type heating source. For example, the oven may be an electric or gas oven. For example, the heating methods of the cooktop 1730 and the oven may be different from each other.

The cooking device 17 may include a main body 1710 including an inner case 1711 in which a cooking chamber 1720 is formed and an outer case 1712 coupled to an outside of the inner case 1711 and forming an exterior of the cooking device 17. Each of the inner case 1711 and the outer case 1712 may be formed to open the front surface thereof.

The cooking device 17 may include a cooktop 1730 provided at an upper end of the cooking device 17 and on which a container including food is disposed and heated. The cooktop 1730 may be provided with at least one heating unit 1731. The container containing the food may be disposed on the heating unit 1731 to be heated. The cooktop 1730 may be omitted in the cooking device 17.

The cooking device 17 may include a door 1750 provided on a front surface of the main body 1710 and opening and closing the cooking chamber 1720.

The outer case 1712 may include a front panel 1713 forming a front surface of the main body 1710, a side panel 1714 forming a side surface of the main body 1710, and a rear panel 1715 forming a rear surface of the main body 1710.

An opening may be provided in the front panel 1713, and a front surface of the cooking chamber 1720 provided inside the main body 1710 may be opened by the opening. A control panel 1741 covering a front surface of an electrical room 1740 may be provided at an upper portion of the front panel 1713.

A display module 1760 may be mounted on the control panel 1741. The display module 1760 may include a front plate 1761 provided on the front surface of the display unit. The front plate 1761 may be mounted to protect the display unit of the display module 1760, but is not limited thereto, and may be mounted as a touch panel capable of receiving the user’s touch command. The display module 1760 and a circuit board assembly included in the display module 1760 are described below with reference to, e.g., FIGS. 2-14.

The control panel 1741 may be disposed on at least a portion of the main body 1710. For example, the control panel 1741 may be disposed at an upper side of the main body 1710. For example, the control panel 1741 may be disposed on the upper side of the front surface of the main body 1710.

An inlet 1715a may be provided in the rear panel 1715 such that air is drawn into the electrical room 1740. Air drawn into the electrical room 1740 through the inlet 1715a may flow inside the electrical room 1740 and cool electrical components disposed inside the electrical room 1740. The air flowing inside the electrical room 1740 may be discharged to the front of the cooking device 17 through the outlet 1780 along the discharge flow path 1772. The outlet 1780 may include a space between the front panel 1713 and the control panel 1741. However, embodiments of the disclosure are not limited thereto, and the outlet 1780 may be provided at various positions to discharge the flowing air inside the electrical room 1740. The inlet 1715amay be formed at various positions for introducing air into the electrical room 1740 as well as the rear panel 1715.

The cooking chamber 1720 may be formed by a top plate 1721, a bottom plate 1722, both side panels 1723 disposed to face each other, and a rear panel 1724. The cooking chamber 1720 serves as a cooking space, and a front surface is opened through the opening of the front panel 1713 such that food may be loaded and unloaded.

The plurality of supports 1725 may be provided on inner surfaces of the both side panels 1723. The plurality of supports may be provided to protrude in the inner direction of the two opposite side panels 1723. At least one detachable rack 1726 capable of placing food thereon may be mounted on the plurality of supports 1725. For example, the plurality of supports 1725 may extend in a horizontal direction to horizontally mount the rack 1726.

A rail capable of dividing the cooking chamber 1720 into a plurality may be installed on the plurality of supports 1725. A user may move the rack 1726 through the rail. A divider capable of dividing the cooking chamber 1720 into a plurality sections may be detachably mounted on the plurality of supports 1725. The user may use the space of the cooking chamber 1720 divided into a plurality of sections in various manners according to intentions. The divider may be formed of an insulation material to insulate each of the divided spaces.

A heater 1727 heating food may be provided in the cooking chamber 1720. The heater 1727 may be an electric heater including an electrical resistor. However, embodiments of the disclosure are not limited thereto, and the heater 1727 may be a gas heater that generates heat by burning a gas.

A circulation fan 1728 circulating air of the cooking chamber 1720 such that food is evenly heated and a circulation motor 1729 driving the circulation fan 1728 may be provided on the rear panel 1724 of the cooking chamber 1720.

A fan cover 1728a covering the circulation fan 1728 may be provided on a front of the circulation fan 1728, and an outflow hole 1728b provided for air to flow may be formed in the fan cover 1728a.

An open front surface of the cooking chamber 1720 is opened and closed by the door 1750, and the door 1750 may be coupled to the main body 1710 to be rotatable relative to the main body 1710. For example, the door 1750 may be coupled to the main body 1710 by a hinge 1751 provided at a lower portion of the main body 1710.

A handle gripped by the user such that the door 1750 opens and closes the cooking chamber 1720 may be provided at an upper front of the door 1750.

A knob assembly 1790 capable of operating the cooking device 17 may be provided on the control panel 1741. A plurality of knob assemblies 1790 may be provided according to the number of heating units 1731 to be operated. For example, four knob assemblies 1790 may be provided as shown. According to an example, the knob assembly 1790 may operate in a push-to-turn manner.

An insulation material 1720a preventing heat of the cooking chamber 1720 from being transferred to the electrical room 1740 may be provided between the electrical room 1740 and the cooking chamber 1720. The insulation material 1720amay insulate the electrical room 1740 and the cooking chamber 1720. The insulation material 1720amay overall cover the outside of the cooking chamber 1720 to prevent heat of the cooking chamber 1720 from being transferred to the outside of the cooking device 17, as well as the space between the electrical room 1740 and the cooking chamber 1720.

Since an inside of the electrical room 1740 may rise in temperature due to heat of various electrical components, the cooking device 17 may be provided with a blower 1770 capable of cooling the electrical room 1740 by circulating air around the electrical room 1740. The blower 1770 may include a blower fan 1771 for flowing air and a discharge flow path 1772 provided to discharge air sucked by the blower fan 1771 to the front of the cooking device 17.

The blower fan 1771 may draw in air in an axial direction and then discharge the air in a radial direction. In other words, the blower fan 1771 according to the disclosure may be a centrifugal fan. Alternatively, the blower fan 1771 may include an axial fan.

A portion of the air inside the cooking chamber 1720 may be drawn in toward the discharge flow path 1772 through a cooking chamber flow path 1773 and discharged to an outside of the cooking device 17. For example, the air inside the cooking chamber 1720 may be discharged to the front surface of the cooking device 17.

The discharge flow path 1772 may include a bypass hole 1774 allowing a portion of air flowing to the outlet 1780 to flow into the cooking chamber flow path 1773. The bypass hole 1774 may be opened or closed by an opening/closing device 1775. As the bypass hole 1774 is opened/closed by the opening/closing device 1775, the amount of the part of the air flowing from the discharge flow path 1772 to the outlet 1780 and introduced into the cooking chamber flow path 1773 may be adjusted. The amount of air exhausted from the cooking chamber 1720 to the cooking chamber flow path 1773 may be adjusted using the air flow adjustment.

According to an example, the cooking device 17 may include a door opening and closing device 200. The door opening and closing device 200 may refer to a device configured to automatically open and close the door 1750 by driving a motor according to an external input, rather than the user directly operating to open or close the door 1750. Here, the door opening and closing device 200 is substantially identical or similar to the door opening and closing device 200 described in connection to FIGS. 4-13. Since driving and operation of the door opening and closing device 200 have been specifically described in connection to FIGS. 4-13, the description is omitted hereinafter.

In the present disclosure, a refrigerator 1, a dishwasher 140, and a cooking device 17 have been described as examples of a home appliance to which the door opening and closing device 200 is applied, but embodiments of the disclosure are not limited thereto, and the door opening and closing device 200 may be provided in any home appliance configured to automatically open and close a door.

What is claimed is:

1. An appliance comprising:
a door; and
a door opening and closing device configured to open and close the door, wherein the door opening and closing device comprises:
a motor;
a first gear configured to receive power from the motor, the first gear comprising a hollow portion, a plurality of groove portions formed along a circumferential direction on an inner circumferential surface, and a groove wall disposed between the plurality of groove portions;
a second gear comprising a rotation shaft inserted into the hollow portion of the first gear; and
an elastic body coupled to the rotation shaft and having an elastic force in a radial direction of the rotation shaft, a portion of the elastic body being inserted into a groove portion of the plurality of groove portions of the first gear.

2. The appliance of claim 1, wherein the door opening and closing device is configured to transmit power of the first gear to the second gear in a state in which the elastic body is caught on or in contact with the groove wall.

3. The appliance of claim 1, wherein the plurality of groove portions comprises a first groove portion and a second groove portion, and
wherein the groove wall is located between the first groove portion and the second groove portion.

4. The appliance of claim 3, wherein a circumferential length of the first groove portion and a circumferential length of the second groove portion are substantially equal.

5. The appliance of claim 1, wherein while the elastic body moves along one groove portion among the plurality of groove portions, power transmission between the first gear and the second gear is configured to be released.

6. The appliance of claim 1, wherein the door opening and closing device further comprises a door-side gear configured to transmit power between the second gear and the door.

7. The appliance of claim 1, wherein a diameter of the rotation shaft is smaller than a diameter of the hollow portion of the first gear.

8. The appliance of claim 1, wherein in a case that the motor is driven such that the first gear rotates in a first direction, the door opens, and, in a case that the motor is driven such that the first gear rotates in a second direction opposite to the first direction, the door closes.

9. The appliance of claim 1, wherein the elastic body comprises an upper elastic body and a lower elastic body spaced apart from each other in a vertical direction, and
wherein the plurality of groove portions comprises an upper groove portion and a lower groove portion spaced apart from each other in the vertical direction.

10. The appliance of claim 1, wherein the elastic body comprises:
a body portion;
a spring received within the body portion; and
a head portion supported by one side of the spring, a portion of the head portion being received within the body portion.

11. The appliance of claim 10, wherein the head portion has a ball shape.

12. The appliance of claim 1, wherein while the first gear is rotated in a first direction by the motor, in a case that the second gear is rotated in a second direction opposite to the first direction by an external force, the elastic body is configured to pass through the groove wall and move along an adjacent other groove portion.

13. The appliance of claim 1, wherein the motor is configured to continue operating according to a predetermined input value in a case that a force acts in an opposite direction while being driven to open or close the door.

14. The appliance of claim 1, wherein the elastic body is a ball plunger.

15. The appliance of claim 1, wherein the appliance is at least one of a refrigerator, a dishwasher, or a cooking device.
